(19) United States
(12) Patent Application Publication
(10) Pub. No.: US 2024/0323748 A1
(43) Pub. Date: Sep. 26, 2024

(54) Wireless Communication Utilizing Selective Bonding with Cellular Network Slices and Sub-Slices

(71) Applicant: LIVEU LTD., Kfar Saba (IL)

(72) Inventor: Baruch Yosef Altman, Pardes Hanna (IL)

(21) Appl. No.: 18/604,548

(22) Filed: Mar. 14, 2024

Related U.S. Application Data
(60) Provisional application No. 63/491,210, filed on Mar. 20, 2023.

(51) Int. Cl. H04W 28/02; H04W 28/24

(52) U.S. Cl. CPC H04W 28/0268; H04W 28/24

(57) ABSTRACT

A cellular transmitting device transmits to a recipient device, using an associated transmitter, outgoing packets that belong to a single particular application. The cellular transmitting device has a Bonding Unit which selectively allocates, at an application level or at Internet Protocol (IP) level: a first subset of the outgoing packets of that single application, for transmission over a first communication link that utilizes a first cellular slice of a cellular network; and a second subset of the outgoing packets of that single application, for simultaneous transmission over a second communication link that utilizes a second cellular slice of that cellular network. Optionally, a plurality of cellular transceivers or cellular identity profiles are used, to transmit in concert the different subsets of the outgoing packets of that single application, via a plurality of transceivers or via a plurality of cellular slices of different cellular networks. The Bonding Unit optionally selects cellular sub-slices that can be carved or manifested or designated at the cellular network level.

### CROSS-REFERENCE TO RELATED APPLICATIONS

This patent application claims benefit and priority from U.S. 63/491,210, filed on Mar. 20, 2023, which is hereby incorporated by reference in its entirety.

### FIELD

Some embodiments are related to the field of communication systems.

### BACKGROUND

Millions of people use computers and electronic devices every day. For example, smartphones are utilized for placing and receiving phone calls, for browsing the Internet, for playing games, for capturing images and video clips, for engaging in Instant Messaging (IM), and for other purposes.

### SUMMARY

Some embodiments provide devices, systems, and methods for wireless communication utilizing selective IP-bonding with cellular network slices and/or a network with sub-slices or any other differentiated resource allocation by the network or multiplicity of networks.

Some embodiments provide devices, systems, and methods for wireless communication utilizing selective bonding, with cellular network slices and sub-slices. For example, a cellular transmitting device transmits to a recipient device, using an associated transmitter, outgoing packets that belong to a single particular application. The cellular transmitting device has a Bonding Unit which selectively allocates, at an application level or at Internet Protocol (IP) level: a first subset of the outgoing packets of that single application, for transmission over a first communication link that utilizes a first cellular slice of a cellular network; and a second subset of the outgoing packets of that single application, for simultaneous transmission over a second communication link that utilizes a second cellular slice of that cellular network. Optionally, a plurality of cellular transceivers or cellular identity profiles are used, to transmit in concert the different subsets of the outgoing packets of that single application, via a plurality of transceivers or via a plurality of cellular slices of different cellular networks. The Bonding Unit optionally selects cellular sub-slices that can be carved or manifested or designated at the cellular network level.

Some embodiments may provide other and/or additional benefits and/or advantages.

### BRIEF DESCRIPTION OF THE DRAWINGS

FIG. 1 is a schematic block-diagram illustration of a communication network or a communication system 100, that may utilize dynamic/adaptive/selective bonding of cellular slices and/or cellular sub-slices (or nested slices), in accordance with some demonstrative embodiments.

FIG. 2 is a schematic block-diagram illustration demonstrating several examples of combinations of bonded cellular slices and/or sub-slices (or nested slices), in accordance with some demonstrative embodiments.

FIGS. 3A, 3B and 3C are a flow-chart of a demonstrative flow of operations of a method, in accordance with some demonstrative embodiments.

FIG. 4 is a schematic illustration demonstrating examples of utilization of multiple cellular slices, in accordance with some demonstrative embodiments.

FIG. 5 is a schematic illustration demonstrating nested slices and sub-slices, across two different cellular communication networks, in accordance with some demonstrative embodiments.

### DETAILED DESCRIPTION OF SOME DEMONSTRATIVE EMBODIMENTS

Some embodiments perform, use and/or provide bonding of communication channels while utilizing multiple slices (and/or sub-slices, nested slices) of cellular communication network(s) and/or other differentiated cellular communication resources or cellular network infrastructure resources. The same applies to any future wireless network types, such as Wi-Fi, that may use the “slicing” concept or mechanisms.

For example, some embodiments utilize multiple 5G slices (from the same single cellular communications operator; or from multiple such operators) and/or other differentiated resources (from the same cellular operator, or from multiple operators) to bond, or multiplex, or aggregate at the networking and above level (e.g., application level) in the 7 layers OSI communication paradigm, multiple connections into one or more bonded and/or multiplexed connections.

The system and method of the present invention may be used in conjunction with transfer of any type of data, including (but not limited to) live audio/video transmission, or transmission or uploading of audio/video or of streaming audio/video or of live audio/video that depicts currently happening events (e.g., being different from pre-recorded audio/video or previously-stored audio/video files), receiving audio/video at the 5G end device, receiving and transmitting simultaneously, transferring one or more large files (transmitting or receiving), images/pictures/multimedia items/animated items/audio-video items, streams of data, streams of audio or video or audio-and-video, related metadata, control and synch packets and/or any other traffic type or packets. The term “video” has used herein may include any of the above-mentioned types of data or a combination thereof; and similarly, the terms “video transmission” or “video reception” may include transmission or reception of any of the above-mentioned types of data or a combination thereof. In such case, the transmission or transfer or uploading or streaming of such live or generally-live video may include dynamic rate and/or bandwidth control of the output of a video encoder that is operably associated with the transmitting device or the transmitter unit, according to the actual/momentary/predicted/current/estimated performance of each connection and/or communication link (e.g., that is participating in a bonded communication multi-link channel), and/or by performing other modifications to the encoding or compression of the data that is intended to be uploaded or transmitted (e.g., dynamically modifying an encoding bitrate of video frames or a video stream, based on said performance characteristics of each such communication link that participates in the bonded communication channel).

In accordance with some embodiments, such bonding at the application level of packets being transmitted in multiple cellular links that were allocated by one or more cellular networks to run over one or multiple cellular communication slices (e.g., multiple 5G slices) may be performed for a variety of reasons and/or to achieve one or more goals; for example: for bandwidth aggregation to achieve high or increased throughput or goodput, increased stability, increased resilience, increased reliability, improved coverage (e.g., to provide cellular coverage in a location that has weak or low cellular reception/transmission conditions, due to geographical remoteness, due to topological features, due to weather conditions), to mitigate or prevent congestion of cellular network and/or communication resources, to reduce latency or communication delays, to reduce jitters or jittery performance at the output or at the transmitter side or at the receiver side, to increase video resolution and/or bitrate and/or other quality or quality-related characteristics, to increase or enhance viewing experience, to transmit additional content with the video (e.g., metadata, subtitles, captions, synchronization data, accompanying data, one or more audio tracks or supplemental or alternate audio tracks), to transmit multiple video streams simultaneously or near simultaneously in a variety of same or different qualities, to reduce communication costs, to spread or distribute communication costs, to provide an increased run time, to provide redundancy among multiple communication links, to use in a more efficient way one or more standard communications protocols such as Multi-Path TCP (MP-TCP)) or QUIC or others, to avoid using a special or proprietary receiver or proxy or dedicated bonding-related buffers while still using multiple communication links in parallel or in concert to transport data from a single transmitting device to a single receiving device or across other type of point-to-point or one-to-one communication channel, to transmit directly over multiple links directly to a standard-based receiving IP stack, to enable pooling of several UEs (User Equipment devices) or cellular modems or (e)SIMs or other billable identifiers into a shared “bin” or group of network performance that is shared only between or among themselves and/or shared that is with other “bins” or groups of other billable or otherwise-grouped identifiers, and/or to enable a transmission that gains other possible benefits from utilization of a mixture or assembly or combination of different types of communication links and/or cellular communication slices and/or cellular nested sub-slices (as described herein).

A cellular communication slice, or a 5G/6G cellular network slice, and similarly any other current or future differentiated resource made available to a UE or modem or SIM or link or other identifiable entity, may be identified or referred to via its dedicated slice_ID or Slice-ID or other unique identifier or other explicit or implicit identification method or alias or pointer. Each particular cellular communication slice may have various particular attributes, network resources allocated to it and/or implementing it and/or supporting it, transmission capabilities, reception capability, cellular coverage capabilities or region, Quality of Service (QOS) attributes, Service Level Agreement (SLA) attributes that may be associated with it, and/or other slice-specific attributes; thereby impacting or affecting the actual performance and Quality of Experience (QoE) when using that particular slice (e.g., particularly under a set of conditions). A slice may be permanent or temporary set-up and torn-down. It is clarified that in other wireless cellular communication standards or protocols, including future ones, other means, methods, or terminology of allocating or assigning or dedicating differentiated cellular resources may be applied, without necessarily calling them “slices”; and some embodiments of the present invention may be utilized with such other methods or standards or protocols, and may refer to “cellular communication slices” interchangeably to refer to other types of mechanisms for allocating or assigning or dedicating differentiated cellular resources.

In some embodiments, a collection of cellular communication slices may include: (a) two or more permanent or long-term cellular communication slices, from one single cellular communication operator or that are served by (or that are defined within) a single cellular communication network; and/or (b) two or more temporary or ad-hoc or short-term cellular communication slices, from one single cellular communication operator or that are served by (or that are defined within) a single cellular communication network; and/or (c) two or more permanent or long-term cellular communication slices, from two or more cellular communication operators or that are served by (or that are defined within) two or more cellular communication networks; and/or (d) two or more temporary or ad-hoc or short-term cellular communication slices, from two or more cellular communication operators or that are served by (or that are defined within) two or more cellular communication networks; and/or (e) a collection of group or set of two or more of the above options or types-of-slices; or in some embodiments, optionally, a cellular communication slice may optionally include (or may be divided into) one or more “sub-slices” or child-slices or nested slices, or a slice or a sub-slice may be nested within another slice or another sub-slice; or any other differentiated resource or resources allocated by the network for serving a modem or link or SIM or IMSI or terminal or user device or a selected group of such and has at least one performance or quality or other attribute associated with it.

Some embodiments may refer to transmission of a first subset of outgoing packets via a first cellular slice (or a first cellular sub-slice); and a “simultaneous” transmission of a second, different, first subset of outgoing packets (of the same application, or of the same data-stream) via a second, different, cellular slice (or a second, different, cellular sub-slice). It is clarified that such “simultaneous” transmission may include, for example, a situation in which the first subset of data packets are transmitted out during a first time-period T1, and the second subset of data packets are transmitted out during a second time-period T2, such that time-period T1 and time-period T2 are entirely and exactly overlapping to each other, or, they have at least a common or partially-overlapping time-period; or, such that time-period T1 includes in it at least a partially overlapping segment of time-period T2; or, such that time-period T2 includes in it at least a partially overlapping segment of time-period T1; or, such that both time-period T1 and time-period T2 include in them the same time-segment (e.g., the same time-segment of 0.1 millisecond, or the same time-segment of 0.01 millisecond); or other scenarios of concurrent or generally-concurrent or substantially-simultaneous transmissions, or transmissions during time-slots or time-windows that are at least partially overlapping to each other; or scenarios where a higher IP layer or an application layer, delivers the packets to a lower/transmitter layer (or layers) requests or commands or indicates that these packets are (or should be, or may be) transmitted during the same time-slots (or, at least partially overlapping time-slot or time-period) of those higher layer or application layer.

Some conventional systems had described the process of creating a cellular communication slice (but not the new invention here of sub-slice or nested or child slices), or creating multiple such slices, or deploying such slices in a cellular network, or moving packets over such cellular network deployments. In contrast, embodiments of the present invention utilize such created or established cellular communication slices, or at least one such slice, or a plurality of such slices; in any single cellular network or across two or more cellular networks and/or operators; in accordance with any suitable form(s) or topology/topologies or domain(s) (e.g., a segment in a private domain or a private region of a cellular network, and a segment in the public domain or the public region of that same cellular network or of another cellular network). Also in contrast, some embodiments of the present invention provide a new architecture and topology where nested slices, or sub-slices, or child-slices, are created and/or defined and/or configured and/or dynamically modified by the relevant network(s), to be used by said terminals or users or end-user devices according to various parameters and needs; some of the embodiments use conventional slices and/or the new sub-slices for bonded transmission of packets or data or packetized data or encapsulated data.

Some embodiments of the present invention may optionally utilize federated network slicing, in which a slice is created from two or more physical networks and/or by utilizing two or more Internet Protocol (IP) types or versions.

Some conventional systems utilize or mention “bonding” in an unrelated way that is not related to embodiments of the present invention; for example, a conventional system that utilizes the Flexible Ethernet (FlexE) protocol for optical networking where “Bonding” of multiple Physical Layers (PHYs) is performed in order to support a higher rate (e.g., “bonding” together, in a conventional system, four 100-GB PHY layers to achieve a combined 400-GB MAC layer). Such conventional “bonding” of PHYs of optical networking elements or PHY layers or MAC layers is not utilized by embodiments of the present invention, and has nothing to do with the bonding of cellular communication slices that some embodiments of the present invention perform and/or utilize, except for potentially being part of the 5G network and therefore indirectly serving the embodiments of the present invention similarly to any computer or networking device or public connectivity or even power supply. Embodiments of the present invention are not about “bonding” at the PHY or MAC layers, and do not utilize such “bonding” and do not require such “bonding” and do not rely on such “bonding”; and do not focus on creating slices using such methods, or on the way to do or manage or optimize network resources or entities in general.

Similarly, embodiments of the present invention do not focus on the process of communicating between two cellular network infrastructure nodes; or on managing the underlying network resources and protocols that support the operation of a cellular network slice (in contrast with the innovative sub-slices as one optional component in the present invention); or on network resources management and optimization (e.g., by having the network aggregate resources), or on the network-side management of multiple slices and their network resources (in contrast with the innovative configuration and management of sub-slices in the present invention); or on the mapping of network resources (or network services, or network applications) to a single slice of a single cellular provider. However, in contrast with conventional systems, some embodiments of the present invention do innovatively introduce, define, configure and utilize a new architecture of sub-slices or nested slices or tiered slices or child-slices; and the definition, creation, management, operation, utilization and/or management of such slices and the innovative optional component of sub-slices or child-slices, as well as their bonding and/or combination, are one of several aspects of some embodiments of the present invention.

Rather, embodiments of the present invention are mostly directed to using such already-created and already-managed cellular communication slices or cellular network slices, that are already manifested in a network catalog or in a particular network topology or architecture or that are already created and published towards the User Equipment (UE) device, and/or the innovative sub-slices. From here onwards, the term “slice” refers in an inclusive way also to the innovative sub-slices (or nested slices, or child slices) of the present invention, according to the relevant context.

For example, in some embodiments, a UE device, or an application or an “app” running on it, may utilize for its uplink (UL) communication and/or for its downlink (DL) communications, two or more cellular network slices that were already created and are already maintained by a single cellular network operator or by multiple cellular network operators or networks, in a new way that creates and enables higher bandwidth and/or higher throughput and/or higher “good-put” and/or reduced latency and/or increased resilience and/or increased reliability and/or improved geographical coverage and/or having a higher level of confidence, reliability, redundancy and relatively predicted QoS and/or QoE. Some embodiments of the present invention are configured to enable utilization of multiple cellular network slices together, at the UE device's IP-stack level and/or above it (such as at the application level that runs on the UE); by splitting or dividing or allocating or grouping or assigning at least part of the relevant traffic that is intended to be transported or that is being transported to/from UE, over the multiplicity of network slices (of a single cellular network, or of two or more cellular networks), or over the multiplicity of such already-created and already-managed network(s) slices, in an innovative “bonded” or IP-aggregated or combined way (rather than by performing carrier or channel aggregations or any other PHY or MAC level aggregations); thus providing a predictable and reliable broadband connection as well as reliable service and high QoS.

The Applicants has realized that in 5G Stand Alone (5G-SA), and similar or future or replacement networks, it may be possible for a single modem (e.g., a User Equipment (UE) device, such as a smartphone) to connect with the cellular network infrastructure, and to send and receive cellular data, via multiple “cellular network slices” simultaneously or concurrently or in parallel to each other or in near simultaneously or simultaneously-transparently to the user application and external IP stack, or during time-slots that are at least partially overlapping or concurrent, or near concurrently. Each such slice is associated with (or provides) a level of QoS service and/or is supported by a different set of cellular network resources and policies (e.g., as defined and managed by the operator of the cellular network in the cellular network infrastructure. It is noted that in some embodiments, optionally, this may be done based on pre-defined rules or conditions or policies, and/or by utilizing an Artificial Intelligence (AI)/Machine Learning (ML)/Deep Learning (DL)/Neural Network (NN) engine or model, rather than by a human operator. Two cellular slices belonging to the same network or operator will usually have two different levels of such QoS; whereas two cellular slices belonging to two different cellular networks or operators may often have the same, or sufficiently the same, or different levels of such QoS.

For example, in some embodiments, the same UE device may utilize at least one cellular modem or transceiver or transmitter or receiver associated with at least one physical or logical/software-based profile or subscriber identity module (SIM) or eSIM or international mobile subscriber identity (IMSI) number or universal integrated circuit card (UICC) or embedded UICC (cUICC) or other subscriber or other identifiers, concurrently or simultaneously, for uploading or for transmitting or for streaming (or for receiving) a single stream of video or live video (or any other type of traffic or data), by using: (A) a first Slice, denoted SL-1, which may be a “standard quality” cellular network slice having a “best effort” type of QoS, which provides no or very low minimum level of guaranteed QoS or no minimum level of guaranteed bandwidth or throughput; and also (B) a second, different, Slice, denoted SL-2, which may be a “premium quality” slice, which may be available from the same cellular network or from a different cellular network, wherein the second slice SL-2 is associated with a so-called guaranteed level of QoS or a so-called guaranteed minimum bandwidth (e.g., providing a QoS or bandwidth guarantee to this particular SIM or IMSI or subscriber or user-profile, or to any SIM or IMSI or subscriber that meets certain conditions or that pays a premium) which performs differently by allocating particular or additional cellular network resources in the cellular network infrastructure to data transported over such “premium quality” slice. The premium performance or the different behavior of the second Slice may be set by the cellular operator in order to guarantee (e.g., excluding pre-defined or uncontrolled phenomena such as RF interferences or failures or being geographically remote from the cell) a particular minimal rate of uplink (UL) bandwidth, a particular maximum UL latency, a particular maximum level of jittery behavior or jittering changes or abrupt changes in either of these parameters, or to guarantee other performance characteristics for uploading and/or downloading data via such network slice. If SL-1 and SL-2 are from two different cellular networks, then usually two different modems or transceivers—each associated with its own SIM or profile identifier or similar identifier which are different than these used by the other slice, except in cases where a single dual-SIM or similar transceiver or modem is used, where still usually two different SIMs or such identifiers are used-one per cellular network with which the slice that it is associated with or served by.

In certain implementations of 5G-SA, a single UE device may use multiple slices simultaneously. In accordance with some embodiments, portions of the discussion above or herein that refer to a “UE device”, mean a device having or associated with exactly one, single, cellular modem. In accordance with other embodiments, portions of the discussion above or herein that refer to a “UE device”, mean a device having or associated with two or more cellular communication modems (or cellular transceivers); which may operate via one or two (or more) cellular networks and/or cellular operators; and/or which may be registered as subscribers at one or two (or more) cellular service providers; and optionally, each one of said cellular modems (or cellular transceivers) may be regarded as a “UE device” for the purpose of optionally bonding together two or more communication links and/or utilizing in parallel two or more cellular slices or sub-slices or tiered slices or nested slices.

In some implementations, each slice is used for a different application or a different data type, depending, for example, on its desired QoS versus the usage cost (which might be associated with the higher performing slices). One such 5G cellular mechanism for routing per QoS is referred to as “UE route selection policy (URSP)” as termed in 3GPP 5G. Additional technical specifications may be needed to fully implement this, either for 5G or for other Radio Access Technologies (RATs), or for other or additional differentiated resources rather than simply defining slices in the cellular network. Slices of a cellular network are considered as one type of such differentiated cellular network resources in the discussion herein. Such differentiated cellular network resources mean that the cellular network, or the network provider or operator, or a subset of these, have resources which are uniquely differentiated or allocated or assigned relative to other resources, that may be allocated to subscribers, UEs, modems, particular SIMs or IMSIs or eUICCs or profile IDs or subscribers or sessions or other consumer(s) of the network resources, and provide various levels of performance, QoS, bandwidth, latency, throughput, behaviors, parameters and characteristics, such as guaranteed (minimal, maximal, typical, range of or any other definition of such; and under optimal or typical or minimal or any other defined or undefined conditions) UL or DL bandwidth, guaranteed UL or DL latencies, guaranteed UL or DL loss or error rates or packet error rate or bit error rate, guaranteed signal-to-noise ratio (SNR), guaranteed UL or DL jitter or stability behaviors in any of the above parameters, or other guaranteed or promised attributes that are enforced by the network infrastructure. Guaranteed, in this context, may mean that it is provided under terms of use, such as distance from a cellular antenna or tower, type of devices, type of UE, type of subscribers, type of contracts, areas of coverage, areas of differentiated service, configurations or provisioning, number of other users, statistical guarantee or probabilities and such as “guaranteed at least 99.99% of the time under the terms of use”), occurrence of a force majeure (e.g., earthquake, hurricane, nature catastrophe), or the like. It may define an absolute, statistical, relative, range, approximated or any other form of definition.

In some embodiments, the ability of a single UE device (or a single modem, or a single transceiver, or a single transmitter, or a single application running on a single UE device) to simultaneously use multiple slices (or other differential cellular network resources) allocated by a cellular network (or by two or more cellular networks) enables a bonding engine or a bonding unit or a bonding module to take advantage of such availability in a variety of ways, as described herein.

In some embodiments, the IP-bonding unit or module or component of the UE device aggregates the IP-capacity enabled or facilitated by the bandwidths of any subset of the available slices (or of all the available slices), thus enabling a single cellular modem (or cellular transmitter, or cellular transceiver) connection to replace multiple cellular modems. Indeed, in some cases, utilization of a plurality of cellular modems/cellular transceivers may still be beneficial for a single UE device; however, some embodiments of the present invention focus on a single UE device that has (or that utilizes, temporarily or continuously in a session) a single cellular modem (or a single cellular transmitter or transceiver) which in turn uses, in concert or in parallel or simultaneously, two or more cellular network(s) slices. Hence, in some embodiments, fewer modems may be used for bonding, including the case of a single cellular modem or a single cellular transceiver and including the case of more than one, to achieve bonding of multiple slices (or other differential cellular resources) from the same cellular network.

In some embodiments, the bonding component or unit may split or divide or may allocate traffic, of the different data streams or sub-streams or of the same data stream (e.g., of a live video stream transmission), over multiplicity of slices, in accordance with a traffic (or packet) division or allocation scheme that matches or assigns or allocated particular types of packets to particular slices representing or approximating or predicting or measuring specific QoS or communication performance. A data stream over a certain slice (or also in general in 3GPP cellular terminology) may be referred to as “PDU Session” or PDP-session (Packet Data Protocol). In some embodiments, the bonding component may aggregate bandwidth from multiple slices of the same cellular network via a single/same modem/terminal and/or subscriber, and/or multiple slices from the same cellular network over multiple modems/terminals or subscribers, and/or multiple slices from multiple cellular networks or operators using a single or multiple modems/terminals or subscribers. In some embodiments, this may mitigate the impact of network (s) congestion that might be experienced in the “best effort” slices or in common cellular slices. The users/subscribers/profiles/SIMs or (e)SIMs or (e)UICCs that are allocated differentiated resources or slices, may then perform better than on the enhanced Mobile Broadband (cMBB) non-differentiated resources, up to being able to perform (for example) live video transmission at high resolution (HD, 4K, or even 8K and various other video quality parameters), 3D, VR (Virtual Reality), XR (mixed Reality), Augmented Reality (AR), or holographic video and/or at high bitrate; whereas, UEs that use only the non-differentiated resources might not get sufficient resources for any operation at all, or for such high-quality/high-bandwidth operation. This may be the case in public networks as well as private ones (e.g., NPN-Non Public Network in 5G terminology and any variation of that, e.g., SNPN-Stand Alone NPN). In some embodiments, bonding of communication links over (or across) multiple cellular slices, by the same UE device, and particularly by the same single cellular modem/transceiver, can result in bandwidth aggregation, latency reduction, and/or other QoS performance parameters improvement which may be desired (or even required) by one or more applications running on the UE device; and may also improve reliability and resilience, particularly if the slices being used are from more than a single cellular network or are from two or more different cellular network operators. The cellular operators/networks may allocate a relatively low guaranteed UL bandwidth for each subscriber/UE on any specific differentiated slice; for example, providing or ensuring or guaranteeing up to 4 megabits-per-second (Mbps) with low latency and low jittery behavior of each. This may not be enough for various applications or usages, such as live video transmission of high quality or high resolution of one or more video cameras (e.g., some Full-HD or 4K or 8K video uploading). It may be, for example, that the network/operator has configured, or allows, only a single differentiated slice in that area at that time; or, that the other differentiated slices that it offers there are less desired for that specific use or application (e.g., their guaranteed latencies are significantly-enough higher, or lower guaranteed jittery behavior). In such cases, the IP-bonding component in the UE device may decide to perform bonding, by splitting or dividing or assigning the video packets (or other packets) that are intended to be transmitted or uploaded, between (or among) or over or across multiple modems, subscribers, profiles, (e)UICCs or other authorized users of the resources, over multiple networks (at least two, but virtually unlimited number of), each offering a slice which is sufficiently close in its guaranteed performance to at least some of the QoS parameters and/or to the performance desired by that application as managed by the bonding component. Hence, multiple narrow bandwidth or lower-than-desired reliability or otherwise insufficient QoS or cellular network resources, yet sufficiently differentiated or guaranteed each one by itself, may be used by the bonding component of the UE device to create the virtual bonded super-link or multi-link channel or multiple-link bonded communication channel, that satisfies its usage/application/communication requirement(s), at any point in time and at any geographic location. Hence two or more cellular slices, from the same or different networks or network operators, but that have sufficiently-similar performance attribute or several attributes, may be bonded together to create a sufficiently homogenized or smoothly performing (and/or transparent to the application) bonded communication channel, over which the packets of that application may be transported (the packets being divided or split across such multiple slices), with minimal or no consideration as to which particular cellular slice each will use in terms of communication performance.

In some embodiments, the bonding component may utilize the information it has, been notified about, measures, estimates, predicts, experiences, or otherwise obtains about specific slices, to set the bonding algorithm parameters and/or the packet-generating application, or for allocating or assigning or dividing packets among the two or more slices; including end-to-end on both transmission and/or receiving sides (e.g., the video encoder-decoder or the data streamer parameters). For example, when the bonding component identifies or estimates or determines that it can use a certain slice SL2 which has certain QoS or parameters associated with it, then it may set or configure or modify bonding system parameters, such as jitter buffer(s) window size(s) (in time units such as milliseconds, or frames, or length) on the receiving side/node/IP-receiver/application-receiver of its transmission. If the slice SL2 has a “guaranteed” performance, such as in maximum or range of UL or DL latencies, or in bandwidth or any other attribute, then for example the guaranteed UL latency may be used to set the receiving side jitter(s) buffer(s) that is used to accommodate for fluctuations in UL latencies in “best effort” and fluctuation cases of no slices or best effort slice, to the maximum latency of a guaranteed latency slice SL2, with or without additional buffer size to accommodate for some small fluctuations that might still happen even with wireless guaranteed slice QoS.

For example, the bonding component of the transmitting UE device may dynamically modify the size of a jitter buffer, the encoding parameters of a video encoder (e.g., video encoding bitrate), and/or other parameters, based on the current and/or momentary and/or measured and/or predicted and/or guaranteed performance characteristics of each cellular slice (or other differentiated resource of the cellular network infrastructure) that is available and that is being utilized for the bonded transmission of packets.

In some embodiments, there may be one or multiple jitter buffers in the receiver. In this case, since using guaranteed or estimated or measured or notified slices, each sub-set of slices has its own performance characteristics, and thus different sized and/or managed jitter buffers may be deployed and used at the receiver side. Each of these jitter buffers and/or their management may be set or configured or modified, dynamically according to the different characteristics of the sub-set of slices that the bonding unit and/or the transmitter use for sending packets.

For example, a bonding device D1 sends first stream of packets that are divided across: a slice SL1 associated with cellular network N1; a slice SL2 associated with that cellular network N1; a slice SL3 associated with another cellular network N2; and/or other slice(s) associated with same or other/additional cellular networks; using a single cellular modem/transceiver, or using a respective plurality of modems/transceivers/terminals, or any other subsets of modems; and dynamically, at each point in time, also sends another stream of packets (e.g., at the same time, or not on the same time) on another subset of network slices, modems and/or networks (of any combination, yet mutually exclusive of the particular set that is associated with the first set or stream of packets). At the receiver side, the receiver may use jitter buffers for each stream of packets, and may dynamically set its parameters and management according to the parameters of the set of slices associated with the respective transmission. For example, the maximal “guaranteed latency” of the first set of slices may be L1, and the maximal guaranteed latency for the second set of slices may be L2. The jitter buffer used for receiving and handling the first stream of data may be set or configured or modified in relation to (or based on or derived from) L1, whereas the jitter buffer for the second stream of packets may be configured in relation to (or based on or derived from) L2. The slices used may provide high probability of being guaranteed; and thus low jittery behavior is expected, and the jitter buffers may be set to relatively smaller size may utilize a smaller size/length/duration.

In some embodiments, the bonding component may decide to use a suitable function or weighting function, that may be based on or derived from one or more of the parameters or attributes or characteristics (whether current, momentary, predicted, estimated, measured, guaranteed, known, or otherwise obtains) with regard to the actually-utilized, currently-utilized, candidates for utilization, available, or soon-to-be-available cellular slices, in order to calculate or estimate or dynamically modify or configure a value of a parameter that is needed for the transmission or that may affect the transmission or that may affect or modify the data that is intended to be transmitted (e.g., a value indicating the size of a jitter buffer on the recipient side; a value indicating an encoding bitrate of a video encoder on the transmitting side). For example, it may decide to calculate the maximum UL latency from a subset of slices of guaranteed performance that include UL latencies, in order to set or configure or modify, in a dynamic manner, the receiving side jitter buffer associated with this transmission in ratio to or in relation to or based on this calculated maximum, with or without regard or factoring in the needed bandwidth, the guaranteed bandwidth, the needed loss rate (or error rate, or bit error rate, or packet error rate, or packet loss rate), the guaranteed loss rate, and/or any other attribute. In another example, the bonding component may calculate or estimate the aggregated guaranteed UL bandwidth of any selected subset of slices, and may dynamically set or modify or configure the transmission rate (and/or related parameters) in relation to such value, and/or may dynamically configure or modify the live video encoder (e.g., modifying its video encoding bitrate, or its video resolution output), to modify its output rate in relation to it, and/or display to the user several possibilities to select from; or may modify the operation of the transmitting device or an associated video encoder or video camera, to switch from encoding outputting/transmitting live video at 720p resolution, to encoding/outputting/transmitting live video at 1080p or 4K resolution (or vice versa), based on the actual or measured or guaranteed or predicted performance characteristics of the cellular slices that are utilized and/or that are available for utilization; or, in another example, set or configure or modify the maximum encoding output bitrate and/or the steps by which the encoding will change in case of changes in the total available bandwidth of the virtual bonded link, in relation to the maximum guaranteed or measured or predicted bandwidth or throughput or good-put of the cellular slices in the bonded link.

In another example, the jitter(s) buffer(s) that are set on the receiving side, may be completely or almost completely eliminated (e.g., minimized in size or duration), or their size may be minimized or reduced to almost zero. In such case, slices (or differential resources of cellular network infrastructure) and their attributes or characteristics are known, measured, estimated, notified, configured, or otherwise obtained or predicted; and in order to have stable and non-jittery behavior, by providing guaranteed or sufficiently-guaranteed or predicted performance (such as for the UL latency) in relation or association to absolute values of that parameter (e.g., UL latency, other performance parameters), or based on other insights that may be deduced from the defined attributes and/or the momentary characteristics of the slices used, the jitter buffer on the receiving side may be eliminated or minimized (in size or duration) or may be almost eliminated (e.g., keeping a jitter buffer that can store up to only 5 or 10 or 20 milliseconds of video, or up to 1 or 2 or 3 or 5 video frames, depending on the frames-per-second (FPS) rate).

In some traffic types that are less sensitive to dropped or missed or lost packets or erroneous packets, or out of order packets, such as some UDP or even TCP traffic depending on the application that runs them, the bonding component may decide to not use a jitter buffer and/or to utilize a reduced-size or minimal jitter buffer on the receiving side. It may then notify the receiving side to accordingly remove or reduce the size of its jitter buffer. In some embodiments, for example, the recipient device may have a Jitter Buffer Activation/Deactivation Unit or module, and/or a Jitter Buffer Size-Modification Unit or module, or a similar logical unit or component or module; which may perform one or more operations to entirely eliminate or deactivate a jitter buffer, or to avoid or skip utilization of a jitter buffer, or to re-configure or change or modify or reduce or decrease the size (e.g., in bytes, and/or in seconds) of a jitter buffer; in response to a signal or an indication that such jitter buffer is not needed and/or that its size may be reduced or minimized. In some embodiments, optionally, the transmitting device and/or a relay node and/or a network element and/or a network function may send a signal to the recipient device, to trigger/request/propose/command such de-activation of a jitter buffer at the recipient device or such size-reduction/size-minimization of a jitter buffer at the recipient device.

For example, in some TCP or TCP-based communications, fluctuations in latency may cause communication problems because the transmission and retransmissions windows, and buffers may be dynamically adapted (e.g., buffer size may be dynamically adjusted or modified) according to the recent round-trip time (RTT) that is measured or estimated. This causes a problem, for example, for continuous live video (and audio/video-A/V) transmission, as the packets need to form a continuous stream at the output of the receiver. This is also a problem when bonding multiple links or modems, each having its own latency parameters and jittery behavior at all points in time, and while the packets intended for transport are split or divided among such multiplicity of communication links, each link has its own latency or reliability or bandwidth characteristics or other ever-changing performance attributes. In such situations, the A/V stream cannot be outputted at the receiver side until all relevant packets have arrived and were re-ordered as needed. However, in accordance with some embodiments, TCP may be used even for live video transmission, or for other applications, if the bonding component decided to bond multiple cellular network slices, on the same network and/or the same modem and/or different modems and/or different cellular networks, such that sufficient “guaranteed” bandwidth at a guaranteed latency, and with sufficiently low jittery behavior of the latency, is measured, configured, estimated, notified, predicted, or is actually provided. In that case, there may not be a need to use a special receiver and/or a special handshake with the transmission bonding device; but rather, a serverless (or receiver-less) bonding system of multiple slices, links, modems and/or networks may be formed, dynamically adapting to the momentary changes in performance characteristics and their fluctuations.

In other embodiments, the bonding/transmitting component may decide to use UDP or UDP-based protocol, while bonding multiple guaranteed slices of any combination of networks, operators, modems or slices. The UDP-based protocol does not require handshake, and can therefore be suitable for communications links that have non-jittery behavior or that have minimal jitters. Using such UDP-based protocol may similarly enable a system with serverless/receiverless bonding of cellular communication links, where the bonding unit on the transmitter side aggregates the bandwidth from multiple cellular slices that have guaranteed latency and/or that have a guaranteed maximum to the jittery behavior of their latency. In such cases, as well as for TCP-based serverless transmission, the bonding component may decide to use certain parameters for Forward Error Correction (FEC) and/or packets duplications, to still mitigate potential fluctuations in the latency or bandwidth or to mitigate loss of packets or data, and may optionally still use jitter buffers (on the receiver side) with very low size or spares size or duration, or no jitter buffer at all.

Setting the correct or efficient values for some parameters, such as the jitter buffer size/duration at the receiver side, or the video encoding bitrate or steps or rate when changing it, may be important; as it affects the end-to-end latency that is experienced by the application, and hence might pose limitations on applications and use cases; and/or since bonding technology that uses “best effort” transmissions may often set some reserve size/duration of jitter buffers in order to accommodate more fluctuations, or alternatively may use more modems in order to increase the probability of having lower latency on at least some of them. In contrast, some embodiments of the present invention provide a bonding mechanism that makes use of expected or notified or predicted or measured or notified behavior (or attributes, or performance characteristic, or guaranteed threshold values, or guaranteed performance attributes) of subsets (or groups) of available cellular network slices, from one modem/SIM/cSIM/IMSI/subscriber or more than one; to reduce the jitter buffer size/duration for at least some cases or in at least some situations, and/or to modify video encoding bitrate or to modify video resolution output or video encoding quantization or any such parameter; thus providing benefits in reducing end-to-end latencies and/or in increasing the number of applications that can use it, as the lower latency now becomes obtainable and is non-prohibitive, and/or by reducing the number of modems or transceivers that are participating in the bonding or that are comprised in/included in/connected to/associated with the transmitting device, and/or by reducing the battery consumption of the device and thus increasing the runtime and/or reducing the device size or form-factor or footprint, or enabling the device to transmit more data or for a longer time while utilizing the same power source or battery.

Server-less/receiver-less bonding with guaranteed performance over slices:

In some embodiments, if the bonding component or unit decides that for specific traffic types (or in general) no jitter buffer is needed, or a minimal-size jitter buffer would suffice, and/or that the performance of the bonded slices SL1 with SL2 is expected, measured, notified, configured or guaranteed to match certain QoS parameters, then it may decide that no special receiving-side server is needed for the purpose of the bonded or single modem transmission (but it may still be needed for activities such as authentication, authorization, video or audio decoding, or the like). In such cases, the device bonding component may transmit the packets over a subset of multiple cellular slices on the same modem or cellular operator, and/or in combination with other slices SLi to SLj from other modems and/or cellular operators, to a standardized/non-proprietary receiver, using IP-based communications (e.g., over TCP, over TCP/IP, over UDP), without special, proprietary or non-proprietary communication protocols between the two sides. Having small jitter buffer, or no jitter buffer altogether, results in lowest possible latency for the applications using the bonding; as the now unnecessary latency that is introduced by a jitter buffer is removed by relying on guaranteed or expected latencies and/or bandwidths. The bonding component may then decide to rely on the information it obtains on the configuration or guaranteed performance and/or the momentary behavior of the various participating or non-participating slices, without requiring a special bonding receiver to mitigate fluctuations or to report back to the bonding component on the device information pertaining to momentary performance of the slices, such as estimated/measured latency, bandwidth or data loss. The bonding component may notify the receiver side about using a specific jitter buffer setting (or range of values thereof, or threshold values thereof). If the bonding component decides to avoid using any jitter buffer at all on the receiver side, such as if the guaranteed performance (bandwidth and/or latency and/or reliability) are sufficient for the data or video stream that it intends to transmit, then it may decide that a jitter buffer on the receiving side is not needed because the aggregated expected performance form the multiplicity of slices that it intends to use is sufficiently stable, reliable, expected or foreseen, and thus the packets will arrive to the receiver mostly in more or less the right order and/or the intended order and without many (or any) missed packets or lost packets or out-of-order packets; thus not requiring re-ordering on the receiving side, at least not at the application level where the mentioned jitter buffer is placed, except potentially for any such reordering being done by standard IP protocol stacks such as TCP (if relevant). The bonding component may therefore decide to avoid using any proprietary server/receiver, and to avoid using proprietary transport transmission encapsulation or protocols; and instead, to use standard IP protocols such as UDP or TCP or TCP/IP or similarly based protocols, including MP-TCP or QUIC or other multi-link protocols. It may then configure or modify the settings/definitions/parameters/values that are related to the Round Trip Time (RTT) window (e.g., of the relevant TCP or UDP link/s) (or other protocol parameters) according to the guaranteed or notified attributes of the multiple slices that are utilized, such as the maximum latency of all the slices that it intends to use or that it is authorized to use for the transmission, with or without an additional (relatively small) spare latency. Such operations may be performed, optionally, by an RTT Window Modification & Configuration Unit or module, or by other suitable component, and/or by the bonding agent/bonding component that is responsible for bonding-related operations and configurations.

The bonding unit of the transmitting device may gather the information that it relies on for its decisions from the slices-related information that is provided by the relevant cellular network(s) in real time, or may have such data pre-configured such as based on data that was obtained from the S-NSSAI or configured or allowed NSSAI data structures (for slices, or as termed in the 3GPP 5G-“route” or “route selection”), “S-NSSAI Network Slice Simultaneous Registration Group (NSSRG)” (which is information constraining which S-NSSAIs can be simultaneously provided to the UE in the Allowed NSSAI), “Data Network Name (DNN)” which may be used to differentiate routing or policies and hence affect QoS, Slice/Service Type, “5G QoS Indicator (aka 5QI)”, Allocation and Retention Priority aka ARP)”, “Guaranteed Flow Bit Rate (GFBR)”, “Maximum Flow Bit Rate (MFBR)”, “Notification control”, “Maximum Packet Loss Rate”, “per UE per Slice-Maximum Bit Rate (UE-Slice-MBR)”, and/or any other data or data structure for any wireless technology (4G, 5G, 6G, SATCOM, Wi-Fi, and any other). Examples include specific RAT access, routing or QoS policies, guaranteed threshold values, guaranteed maximum latency, guaranteed minimum bandwidth or throughput, guaranteed maximum error rate or BER (Bit Error Rate) or PER (Packet Error Rate), or loss rates or other attributes. It may also use and rely on standard Internet traffic measurement protocols and tools, such as “ping” values or similar data, as well as expected fluctuations to the guaranteed performance; and/or adaptive and relative mechanisms that the bonding mechanism may use, such as sending some redundant packets using Forward Error Correction (FEC), or by duplicating/replicating some of the packets on some of the bonded slices, and/or other such mechanisms to increase transmission reliability or resilience or good-put, and may thus provide sufficient reliability for some traffic types including some live video transmissions at various absolute QoS performance (such as, specific UL latencies or bandwidth values, absolute values or in ratio/relation to the guaranteed performances of the participating slices SL1 and SL2 through SLn). In one example, it may send packet PI via slice SL1, and may send a FEC packet generated from PI to Px over slice SL2; it may decide to use slice SL2 as the “reliability” mitigating flow for packets sent over slice SL1; it may decide to split or divide or allocate the packets between (or among) one or more of the cellular slices in accordance with a particular distribution algorithm or distribution scheme, such as round-robin or randomly or by allocating priority levels or other distribution scheme. As a result, the system need not include a special receiving-side bonding component, and the bonding component on the transmitting-side device may transmit to any standard receiver and any standard video decoder, or data networking device, using a standard IP stack without additional encapsulations and/or additional communication protocols, so that the standard receiving-side equipment may then correctly receive, decode and use/display/output the video (or data).

In some embodiments, the relevant device in the system may bond different slices from multiple modems (or, that are allocated or assigned to different modems, of the same transmitting device) for different application performances or for different applications or for achieving or providing or securing different thresholds of performance metrics. For example, for Ultra Low Latency applications, yet with relatively high UL bandwidth needed, such as for low latency live video transmission, the bonding component of the transmitting device (or, that is associated with a transmitting device, or that is operably associated with a video camera and/or a video encoder) may use guaranteed latency slice SL3 from all of the modems/SIMs/VSIMs/cSIMs/IMSIs that are currently available to it, so to achieve very low (or minimal) latency, very low (or minimal) fluctuations of latency and hence very short (or minimal) receiving jitter buffer(s) size(s), high bandwidth needed for high-resolution/high-bitrate/high-quality live video, and resiliency as the multiple modems may be operating on or via different cellular operators. This configuration, however, might or may not come with a “cost penalty”, as in some situations, using such special slices might have premium financial cost(s) associated with them. Hence, for other types of traffic or use cases, the transmitting device may decide not to use such combination of bonded ULL (Ultra Low Latency, and/or URLLC-Ultra-Reliable Low-Latency Communication) latency slices, but rather, to utilize another sub-set or group or combination of cellular communication slices which may cost less or may have no extra cost at all, and/or which may fulfil other set of performance-related and/or cost-related conditions, or otherwise limit in part the use of the more costly slice. In some embodiments, the fact that some particular cellular communication slices may have more deterministic, or predicted, guaranteed, notified or experienced behavior, performance characteristics or performance parameters, may be used by the bonding component to set the bonding parameters, such as jitter buffer size on the receiving side, the Forward Error Correction (FEC) types and parameters on the transmitting side, the transmitted bandwidth per slice, ramp up and/or degradation transmission patterns such as time-to-maximum or to-minimum allocated bandwidth or steps in terms of bandwidth and/or duration and/or intervals of increase or reduction in bandwidth or any other, when recovering or experiencing a problem on that slice (e.g., due to interferences), threshold values associated with the transmission or the receiving side, or the like; and/or to set or configure or modify values of parameters of the packet generating/sources, such as of the video encoder, for example, the maximum encoder output bandwidth or bitrate, explicitly or implicitly by setting any parameters that impact it in order of priority in relation to the available bonded performance, its SVC (Scalable Video Coding) parameters, the resolution of the video encoder output, the video encoding codec and/or its encoding parameters (e.g., whether to utilize H.264 or H.265 encoding), its user interface, the recommended or allowed range of the end-to-end latency, availability of additional QoS-depending services or transmissions, etc. Other such parameters that the bonding mechanism may use when identifying or selecting slices and their expected performance may include, for example: RTT (Round Trip Time) related windows for TCP or UDP based transmissions or other IP stack related parameters. Therefore, in some embodiments, the bonding component may pass these parameters to other applications, which may in turn use it to set their own parameters (such as, the real time video encoder, a security camera unit or application, one or more routers or relay units, load balancers or other network nodes, as well as Operating Systems (OSs) or protocol stacks such as MPTCP (Multi-Path TCP) or QUIC.

The bonding component on the transmitting device side may further inform or notify the receiving side component, to set or to modify one or more parameters at the beginning of the session or transmission, and/or during such session; may notify the receiving side which jitter buffer size to utilize, or which range of values or set of values may be suitable for jitter buffer size at the receiving side; and/or may provide other information to the receiving side to facilitate or to improve the efficient reception of the transmitted data (e.g., live video or other data). Such information may be utilized by the receiving device to set, configure or modify its units or operational parameters accordingly.

In some embodiments, packets allocation/split/division/assigning into data streams and/or to cellular slices and/or to cellular networks and/or to transmitting cellular modems, may dynamically and adaptively be set or modified to depend, or may be changed, or may be selected, according to the measured, configured, notified, sensed, predicted, known or estimated behavior of any of the cellular slices that are associated with it or intended to be associated with it or is a candidate for possibly being associated with it, by the bonding component. For example, if a certain bandwidth, or latency, or data/packet loss rate, or jittery behavior of any of these or other parameters, can be aggregated over a certain subset of the cellular slices (from the same modem and/or from different ones, from the same network or from different ones), then the bonding component of the transmitting device may decide to use a certain subset of that group or subset of slices to transmit or receive a first type or specific packet stream, and to use a second (different) subset of this group or subset of slices for a second packets stream. Each of these may have a different set of bonding, depending on these parameters. For example, if the first subset of slices was selected because they have a relatively similar latency, and/or latency jitter behavior, such as very low latency jitter in the uplink from the device on the same network if they are all associated with the same network or on the multiple networks they are associated with, then the bonding component may decide to send via those slices the packets stream of an application which is sensitive to latency jittery behavior, such as uplink live video transmission. It may also suggest to the user, or automatically choose so or automatically switch to do so, to set or change or configure the encoded/compressed video resolution, or other parameters of that video encoding/compression, so that the generated bandwidth or bitrate would fall within the aggregated bandwidth over this subset of low-latency jitter cellular slices. It may also suggest to the user, or may automatically choose to do so, to selectively and adaptively configure and use certain mechanisms to reduce and/or mitigate the risk of lost packets or lost data or changes in latencies or bandwidth, even though these may be “guaranteed” by the cellular slices, Such mechanisms may include, for example, transmitting duplicate packets (e.g., two or more copies of the same outgoing packet) on different cellular slices, transmitting FEC information or packets on the same slices or via different slices (e.g., to increase redundancy or resilience), and/or other mechanisms.

In some embodiments, the bonding component may selectively or adaptively configure the ramp up and/or degradation behavior and patterns associated with a subset of the selected cellular slices that are utilized for transmission. Such configurations may be with regard to the number, size, duration of steps in the ramp up and/or degradation process when a modification in the transmitted bandwidth is needed or when it occurs. When a certain group or subset of slices is used, for example when they have a certain latency jittery behavior guaranteed, or estimated, or notified, or configured or otherwise associated or assumed to be associated with it, and/or a certain bandwidth or jittery behavior of the bandwidth occurs or is predicted to occur, then the bonding component may decide to use a small and more sizeable and/or shorter steps to ramp up the transmission after the transmission was low in bandwidth, for example, upon session startup or when recovering from certain faults or certain performance drops in the utilized communication links. When another set of cellular slices, for example the best effort eMBB or similar type of slices is used, it may decide to use more and/or smaller and/or longer steps for similar ramp-up transmissions. The estimation and/or measurement and/or deduction that the bonding component may utilize may be, for example, that for guaranteed performing slices, the operational return to normal or guaranteed performance characteristics may be quicker, and/or that the overall performance fluctuations may be smaller for such slices. Similarly, when experiencing or estimating to experience a problem or a degradation in the performance over any particular cellular link of any particular cellular slice from the group of bonded and used cellular slices with guaranteed parameters, then the bonding component may decide to reduce the number of packets being transmitted (e.g., per second, or per minute, or in total), and/or to reduce the number of packets that are being generated (e.g., per second, or per minute, or in total) such as by a live video encoder (e.g., by reducing the video encoding bitrate or other encoding parameters), to a particular level which correlates (or has a calculated or estimated ratio to) the guaranteed performance.

In some embodiments, a bonding device or component may use User Equipment Route Selection (URSP) policies and/or other network/protocol mechanisms to perform bonding, or to aggregate, or to otherwise utilize, multiple cellular slices that available at a certain point in time (T1) and a particular geo-location (G1) for its device transmission or uplink or uploading or up-streaming. In a similar way to the one described below, it may also use any other differentiated services or resources offered by any other wireless and especially cellular standard or protocol, including in future 6G cellular or equivalent cellular networks or protocols.

In some embodiments, the device may connect and use the “best effort” cellular slice (sometimes referred to as eMBB, or denoted SL1 herein) along with one or more high performing other slice/s (denoted SL2 to SLn), each such cellular slice having its own service profile or defined/configured/assigned/guaranteed performance characteristics, as well as its momentary performance characteristics which may be changing over time. The device may take into account in its calculation, prediction, estimation and aggregation of bandwidth, and/or latency performance, in the UL direction and/or in the DownLink (DL) direction. For example, if the “best effort” momentary UL bandwidth on slice SL1 is BW1, as actually measured or as estimated by the transmitting device (or by its receiver that is receiving its packets, or by the network, or by any combination of such elements or otherwise), and an UL bandwidth BW2 on SL2 is foreseen, guaranteed, estimated, announced, notified, measured or otherwise assumed or known, then the transmitting device may use both slices SL1 and SL2, and may split or divide or unevenly distribute the packets of the encoded live video or any other data stream (that is intended for transmission) between the two slices SL1 and SL2; for example, by using a packet distribution scheme that takes into account (or that is based on) the respective known (or guaranteed, or actual, or notified, or sensed, or estimated) performance characteristics of each of the slices SL1 and SL2; and/or may further configure, in real time or in near real time, the video encoder and/or a video-transmission application (e.g., a video conference application, a live video streaming application) or any other application that produces packets for transmission in any relativity or ratio to the total bandwidth available from both slices or to any of each of them, combine them or any subset of them with the other connections available to it so that the packets are split or distributed or allocated between or across all of them, and the configurations of the packet generation applications or devices are configured or modified accordingly in a dynamic manner.

For example, in some cases, the user of the transmitting device or the service may configure or may choose financial cost constraints that may affect the selection of which slices to use and/or how many slices to use. For example, if sufficient performance (UL bandwidth, latency, goodput, throughput, or other) is achieved with utilization of lower-cost cellular slices, such as the “best effort” standard service or slice SL1, then the device or service policy would select to avoid using any higher-performing or guaranteed or differentiated cellular slices (or other differentiated-quality resources of the cellular network) if they cost more, even if such slices or resources are available at that time-point T1 and at that geo-location G1. In other cases, other users may choose to utilize a differentiated-quality or a guaranteed service cellular slice SL2 (or several slices of that type), generally continuously (e.g., for at least N seconds, wherein N is greater than 1), when available, at a maximum UL bandwidth utilization BW1 or without limit, to provide a mitigating “cushion” or safety net or compensation for the more “risky” best effort transmission, particularly for a high demanding transmission (high bandwidth, such as for 4K or 8K video resolutions), especially over wireless (including cellular) connections of which their performance might fluctuate, or might completely drop or suffer loss of signal or coverage, in order to keep at least some transmission at all times and to not break the transmitted stream of data or the live video.

In some embodiments, the transmitting side or device may use the subset of available slices to send packets that represents different parts (or segments, or time-segments, or content-portions) of the video or data stream. For example, a live video stream comprised of encoded video, encoded audio, metadata, clock signal and/or other types of data may be generated and may be intended for transmission or uplink streaming. The transmission or bonding component may decide to use cellular slice SL4 which has “guaranteed bandwidth” of 8 megabits-per-second for uplink transmission of some (or all) of the packets of the encoded video; and in parallel or in concert, to utilize cellular slice SL5 which has “guaranteed bandwidth” of 2 megabit-per-second for uplink transmission of some (or all) packets of the encoded audio; and in parallel or in concert, to utilize cellular slice SL6 which is a “best effort” cellular slice for uplink transmission of some (or all) the packets of the metadata (or subtitles, or captions, or other auxiliary data); and to utilize cellular slice SL7 and/or other slice(s) for performing, in parallel or in concert, uplink transmission of other or more packets or duplicated packets or error protection/redundant packets of the encoded video on the “best effort” slice(s) or on other slices.

In some embodiments, optionally, the transmitting device may be configured such that video data packets are transmitted via a particular cellular slice of their own, or via a particular set of cellular slices that would be dedicated for transmitting video data packets; separately from the one or more cellular slice(s) that are utilized for audio packets transmission and/or FEC packets transmission and/or error correction data transmission and/or duplicated packets. Such configuration may be particularly beneficial for a scenario in which it is important that the recipient would see a live video at all times, even if audio breaks down or if audio is lost (e.g., a security camera that uploads video).

In some embodiments, optionally, the transmitting device may be configured such that audio data packets are transmitted via a particular cellular slice of their own, or via a particular set of cellular slices that would be dedicated for transmitting audio data packets; separately from the one or more cellular slice(s) that are utilized for video packets transmission and/or FEC packets transmission and/or error correction data transmission. Such configuration may be particularly beneficial for a scenario in which it is important that the recipient would hear live audio at all times, even if video breaks down or if video is lost (e.g., a video-conference application or unit, in which it is important for audio to be maintained even if video is lost).

In some embodiments, optionally, the transmitting device may be configured such that FEC data and/or error correction data or duplicates are transmitted via a particular cellular slice of their own, or via a particular set of cellular slices that would be dedicated for transmitting FEC data and/or error correction data; separately from the one or more cellular slice(s) that are utilized for video packets transmission and/or audio packets transmission.

In some embodiments, optionally, audio packets are transmitted via one or more “guaranteed high bandwidth” or “guaranteed low latency” cellular slice(s); whereas, video packets and/or FEC data and/or other data or metadata that is intended for uplink transmission, are transmitted via “best effort” cellular slice(s) or via “non-guaranteed” (bandwidth and/or latency) cellular slices.

In some embodiments, optionally, video packets and audio packets are transmitted via one or more “guaranteed high bandwidth” or “guaranteed low latency” cellular slice(s); whereas, non-video non-audio data, such as FEC data and/or data correction packets and/or metadata and/or captions and/or subtitles and/or other data or metadata that is intended for uplink transmission, are transmitted via “best effort” cellular slice(s) or via “non-guaranteed” (bandwidth and/or latency) cellular slices.

In some embodiments, optionally, video packets are transmitted via one or more “guaranteed high bandwidth” or “guaranteed low latency” cellular slice(s) that are dedicated for uploading of video packets, such as Slice SL1, or such as Slices SL1 and SL2; and in parallel or in concert, audio packets are transmitted via one or more other “guaranteed high bandwidth” or other “guaranteed low latency” cellular slice(s) that are dedicated for uploading of audio packets, such as Slice SL3, or such as Slices SL3 and SLA; and in parallel or in concert, non-video non-audio data, such as FEC data and/or data correction packets and/or metadata and/or captions and/or subtitles and/or other data or metadata that is intended for uplink transmission, are transmitted via “best effort” cellular slice(s) or via “non-guaranteed” (bandwidth and/or latency) cellular slices, such as Slice SL5, or such as Slices SL5 and SL6.

In some embodiments, at least two different cellular slices are allocated for uploading of video packets, which the bonding unit of the transmitting device distributes among them (namely, distributes among two cellular modems M1 and M2, that transmit different video packets of the same outgoing video stream via two different cellular slices SL1 and SL2); whereas, in parallel or in concert, not more that one cellular slice is allocated for uploading of audio packets.

The above are non-limiting examples, which the Applicant have found to be innovatively beneficial in some particular usage scenarios. Other suitable configurations may be used, to achieve other performance goals and/or to take into account other constraints.

The selection of which cellular slices to utilize, and/or the momentary distribution or allocation of packets (that are intended for uplink transmission) to modems and/or to cellular slices, may be dynamically modified according to the measured, notified, predicted, guaranteed, or estimated performance of each of the connections (or cellular slices) or some subset of the slices or other differentiated services or connections, or the combined performance thereof, or the desired or required service level or QoS or QoE for the transmitted packets or streams, or based on characteristics of the produced packets (e.g., video resolution, or video encoder output volume).

In some embodiments, Scalable Video Coding (SVC) or similar schemes or paradigms of layered services or layered QoS may be provided, for example, by sending the basic Coding level packets on the higher performing slice SL2 (or subset of several such slices, and/or in combination or bonding with other links or slices), while the higher layers carrying additional coding information and enabling higher video (or audio) quality at the receiving end decoding are transmitted on lower performing or subset of such slices or other modems or connections.

In some embodiments, a certain slice having guaranteed lower UL or DL latencies, i.e., low jittery behavior of the UL or DL latencies, may be used by the bonding or transmitting component in the device to send or receive (respectively) synchronization frames at low volume. Such signaling packets or synchronization frames or other synchronization signals may be used to synchronize time-sensitive equipment in the same or different geolocations, such as cameras that have to be synchronized for a certain event transmission, at a frame level (e.g. at 25 or 30 or 60 or 120 frames per second, or other values or rates).

The utilization of the various cellular slices, or other differentiated services, may be performed by using one or more mechanisms that may be defined for that purpose or that may facilitate such process. In some embodiments, for example, the URSP defines in part how the information about available slices and/or eligibility of a specific SIM (or eSIM, or UICC, or eUICC, or IMSI or any other profile or credentials or UE identification or subscriber identifier) is provided to the transmitter, including pre-configured and pre-stored on the SIM being used or dynamically being downloaded or notified or published by the relevant cellular network(s). The device's bonding or transmission component may check the available differentiated services (including cellular slices) and their profiles, capabilities, limitations and other information which may be available to it and/or which may otherwise define or describe the performance characteristics of each cellular slice, either once or periodically, or continuously, or at pre-defined time intervals (e.g., every N seconds), or upon an event that it considers as might be requiring using or changing the usage of such differentiated resource, including deteriorating performance measured or expected or notified or estimated on any of the connections or slices or other modems or differentiated services available to it or to other devices (such as based on prior heuristics provided to it from another component residing in the cloud or the cellular infrastructure network component or otherwise).

The device may change the traffic descriptor of the packets according to the packet descriptors associated with the available slice SLx, even if this traffic descriptor (or other identifying or describing parameters) does not fit exactly or 100% to the real or actual traffic type of these packets, so as to gain access to that particular cellular slice SLx. In some embodiments, optionally, a Packet(s) Descriptor Modification Unit or module may be responsible or engaged for modifying or setting or replacing or rewriting or overwriting the values of such packet descriptors for this purpose.

In some embodiments that utilize cellular 5G communications, a field called “Single-Network Slice Selection Assistance Information (S-NSSAI)” may be defined and utilized. The S-NSSAI value identifies each network slice service, and provides information to properly assign network slice/functions. In some embodiments, the device may therefore use S-NSSAI to identify the available slices for that IMSI/SIM/cUICC/VSIM/eSIM/profile/Customer ID/subscriber ID/transmitting modem, to understand the Slice/Service Type (SST) and Slice Differentiator (SD, if such is provided in the S-NSSAI for a specific slice), and from that—other data such as slice priority or known or assumed or estimated capabilities, as well as any other information obtained that may be relevant or associated with one of the identified cellular slices. In some embodiments, other methods for identifying or distinguishing or defining a slice and/or its attributes may be utilized. For example, an indirect method may include: using a different 3GPP cellular APN (Access Point Name) for each cellular slice, or a different “dialing string” or other credentials or parameters to register to the network.

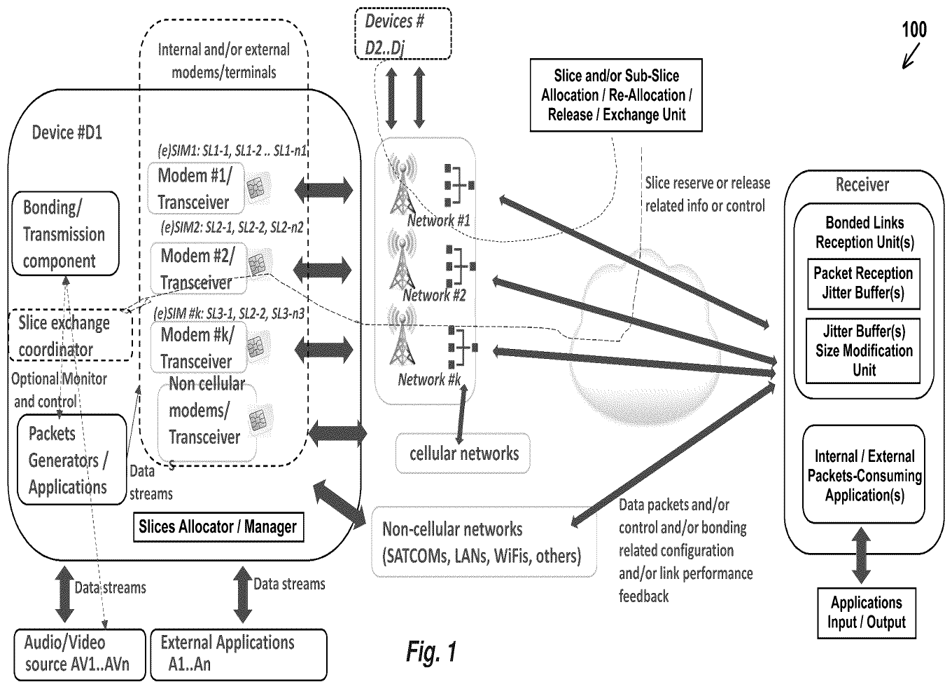

In some embodiments, the device may ask for a specific cellular slice even though it does not need the service level associated with it (e.g., additional bandwidth BWx) at that point in time, in order to force the cellular network functions to allocate the resources and thus, for example, reserve them for a near or far future use by itself or other devices of that UE owner/customer and/or service level when competing service levels are expected, such as in expected congestion situations or time-slots or geo-locations. As the network functions might be allocating resources dynamically according to requests, such “in-advance” request for a guaranteed performance via specific slice subsets SL2-SLy, the device may reserve these resources so later usage, when congestion occurs, such that they are available for subsequent usage; and the device, or other modems or SIMs that are associated with the same “customer ID” or other allowed/authorized/subscribed credentials or profiles, may use such reserved resources and thus avoid or minimize o reduce the congestion. In some embodiments, the first device or devices may use the single or multiple modems in them to engage and hence reserve as much of the resources as possible. Later, and sometimes much later such as hours or days afterwards, more units and/or modems may arrive at that location. All or some of their requests for slices (or differential resources) might then be rejected by the network(s) as these slices, and/or their capacities, are already taken/busy/unavailable. When other devices belonging to or associated to the same customer (or others) arrive, the first devices already occupying the slices may release them, in a controlled or coordinated fashion or without it, so that the new-comer devices may immediately request them and occupy them. Coordination of such “release and occupy” mechanisms may be done manually or automatically with accurate synchronization when the engaging devices communicate either directly or proxied or coordinated via a cloud or server coordination component or via peer-to-peer communication between the “releasing” device and the “newly occupying” device. Such automatic component or resource coordination may be referred to as slice-engagement coordination process or bots, and may be implemented via one or more components residing on the devices and/or the cloud/server as depicted in FIG. 1, “Slice Exchange Coordinator”. The mechanisms or algorithms used for such coordinated “release and occupy” process may be algorithms similar generally to those used by bots to buy or sell stocks, to buy or sell low-volume high-demand products on the Internet, or other algorithms. Releasing occupied slices may be done with or without reward, per known set of rules or according to real time negotiations, either manually or automatically such as between the bots, including using schemes such as tenders, bids, or other reselling and monetization mechanisms.

In some embodiments, access to the 5G (or 6G or others) slices or networks may be allowed via non-cellular RATs (Radio Access Technologies), and slices or differentiated resources, including the access itself into the 5G or other network/operator, may be provided by the cellular operator/network. In such cases, the bonding component may decide to use such access, slices and/or other differentiated resources, for its multi-slice bonded transmission over a single modem or over a bonded multiplicity of modems. Using these preferred or differentiated access, when available, the bonding component may further offload the transmission over the cellular radio (or cellular towers), while still providing guaranteed or at least nearly-guaranteed performance over that other access, hence mitigating and potentially overcoming cellular networks radio congestions, and while providing service and QoS to its applications. Standard protocols and mechanisms that are defined in 3GPP to support such access are defined in standard document such as 3GPP TS 24.502 “Access to the 3GPP 5G Core Network (5GCN) via Non-3GPP Access Networks (N3AN)”; if supported by the modem(s)/terminal(s) and subscribers and network(s) at that time and location, the bonding component may learn of it via the URSP or other data structures, and may utilize it in its multi-slices bonding decisions as described. Additional examples for differentiated services in 5G are such that handle UE policy information: Policy information preconfigured in the UE and/or provisioned to the UE for access selection (i.e. ANDSP), Protocol Data Unit (PDU) Session selection (i.e., URSP), V2X communications (i.e. V2XP) and/or ProSe operations (i.e., ProSeP).

In some embodiments, the bonding or transmission component may disguise or hide or represent or convert packets to a transmission behavior or pattern that one or more relevant verification functions of the network may accept as compliant, and may therefore allow for a specific slice that the bonding component chooses to use for these packets. Such verification functions may be “binding verification”, “flow verification”, QOS verification, Deep Packet Inspection (DPI), Policy verification or any others or combination of such. This may be to encapsulate or wrap the packet, or PDR (transmitted packet in 3GPP or others) in relevant protocol or bytes, handshake in a specific way to establish the session, transmit at a certain rate or volume or packet size or other measurable transmission or packet parameters. Such conversions or encapsulations may be dynamically configured and/or modified by the bonding component. For example, the bonding component may decide to encapsulate or use a certain transmission or packet pattern at the beginning of a session and/or periodically, for all or for certain packets such as “dummy” packets, and hence make the network binding verification functions authorize or allow or accept the usage of that particular cellular slice for this particular stream of packets or for these particular streams of packets. If it concludes or informed that the verification takes place only at certain time-points during the transmission, then it may decide to not encapsulate the data, or to use different transmission or packet patterns at other times, in order to reduce the overhead in transmitted/needed bandwidth, reduce processing power or latencies (due to encapsulation and later de-encapsulation), or the like.

Some embodiments enable to construct a relatively guaranteed, or known, or predictable, or predicted-performance, virtual broadband communication link out of several differentiated resources such as cellular slices in the otherwise unreliable wireless and especially cellular communication. The multiplicity of differentiated resources could be from the same modem or from several modems/networks/(c)SIMs/IMSIs/cUICC/links. By aggregating, or bonding, or splitting, or distributing, streams or packets of data between or among or across several differentiated resources and/or slices with non-guaranteed best-effort resources, the device or application can thus avoid traditional bonding mechanisms such as feedback for the momentary performance of each of the links via proprietary protocols. The bonding unit or engine block can now predict with sufficient accuracy the performance over each of the cellular slices or differentiated resources, and hence load or utilize each of them accordingly; and/or to generate and transmit error correction data and loss prevention packets or bytes in a suitable ratio to the expected performance of one or more of these slices or to all of them; and/or to instruct the receiving side to configure the associated jitter buffer with a very low and even no “spare” duration (or size) over the expected performance of one or more of the maximum performance values of the differentiated resources; and/or to perform degradation of the transmitted bandwidth at a rate and steps and duration in ratio to the expected performance or QoS of that slice, such as when a problem occurs, e.g., measured by “too many bytes or packets not being transmitted over a certain slice or a differentiated resource during a certain period of time, versus the predicted or expected transmission rate”; and/or to perform a ramp-up transmission after the ending of the problem in the transmission, or at the beginning of a transmission in accordance with the expected performance or QoS of that slice; to avoid hysteresis of the transmitted bandwidth as the bonding block can now identify the maximum bandwidth at a certain latency or other parameters as being associated with that resource or slice and hence avoid “overshooting” with a negative result on performance, and/or avoid “undershooting” which results in under-exploitation of the resource and avoid the jittery hysteresis that a network allocation might impose when trying to overshoot and undershoot, but instead to aim for the maximum bandwidth at the desired QoS parameters or independent value(s) and transmit at that exact rate or slightly below it, in absolute value or in ratio to that maximum (e.g., to transmit at 99 or 95 percent of the available bandwidth), slightly under or below that maximum bandwidth. In one example, the ramp up transmission rate can be directly related to the maximum UL bandwidth expected of that slice, rather than going up or increasing in steps. This shortens the transmission set-up time and recovery time. Alternatively, it can try first half that maximum rate or ⅓ of it or other fraction(s) thereof. These alternatives may also reduce the number and duration of steps, and therefore recovery time, as well as its accuracy, and/or may prevent hysteresis and prevent under-utilization. The bonding component may decide to switch to a “binary transmission” mode for that slice; wherein, if the expected bandwidth or other QoS is not experienced at any moment, it would stop transmitting valuable or important or critical packets over it, and may transmit only “keep alive” or “dummy” or “error correction” packets so that the resource is at least maintained operational by the network for this IMSI/modem/(e)SIM/profile/subscriber. Once the bonding component identifies that a certain parameter is achieved, such as RSSI (from the RF level—the received signal level) or RSRP or others from the RF level, or parameters from the application level, such as the delivery of said redundant packets over that slice, or the performance of other slices or differentiated resources from the same network at that time and location, or the information provided by the network such as in S-NSSAI or 5G-5QI or other data structures or parameters in real time or near real time, it may decide to switch back and forth between using the slice/resource and not using it, or using it in a certain “best-effort” paradigm rather than as a known/guaranteed resource. Further, in some embodiments, the bonding component may use a change in the performance of one of the slices or the differentiated guaranteed resources of that network to deduce, predict and therefore adapt or modify the transmission scheme over other slices or differentiated resources of that network, without the need to actually experience the change on them. It may then coordinate the change between any subset of the multiplicity of guaranteed performing slices of that network, such as switching to not using them at that point in time and location, switching back to using them at full or half or other level in relation to the max bandwidth expected from them at the desired and associated QoS performance levels. The bonding component can also coordinate, manage and instruct the generating source(s) of packets that are intended for transmission, such as the live video encoder, to adapt to a specific optimal or improved configuration and output bandwidth as the overall guaranteed resources plus any best-effort risk it may decide to take, can accommodate at that point in time and geo-location. Thus, the bonding component avoids frequent or multiple small steps of setting and changing the video encoder or other packet generator outputs, can command an optimal or improved or dynamically modified configuration for the expected overall performance expected from the multiplicity of guaranteed performing slices plus any best effort risk it decides on, reduce changes in the quality of the video output at the receiving side, and/or minimize or reduce the impact on the network performance due to many changes over a short time or in total. The bonding component may also generate alerts and notifications that are reflected or conveyed to the device or application user (human or machine), which can then react to such notifications or alerts. The bonding mechanism may also generate alerts and notifications to the network or networks, thus allowing it to react or to modify its operational parameters; for example, by increasing the bandwidth allocated to a certain slice or differentiated resource, either in real time or near real time or fir the future, in that specific location and time or also in other locations or times. Optionally, the bonding component of the system may even notify to a network node or router or switch or cellular tower, that a “guaranteed bandwidth” or a “guaranteed low-latency” cellular slice does not actually provide the level of service that was promised; optionally indicating that there is a network malfunction, or that a network node or network element or network function is malfunctioning or non-functioning.

The bonding unit or block may use multiple more reliable wireless resources to create a virtual broadband communication link for the use of the data stream whose packets are split or distributed between them or across them, especially for live video uplink stream with or without associated dynamic adaptation of the video stream source so that its output correlates to the available bandwidth at that QoS.

The modems or transmitters may be embedded within the device, and/or may be external to it, or connected to it via cable or wire) or via a cable-less (wireless) connection, or via a dedicated port (e.g., USB port, PCI or ePCI port, or other interfacing component or data bus).

Some of the drawings do not necessarily show lines connecting between particular components. This is done for sake of clarity, and to avoid over-crowding of the drawings; and as the communications between the blocks is mentioned within the text; and any two (or more) components that appear in any drawing may be in communication with each other, via wired and/or wireless communication links, and/or may otherwise be operably associated with each other.

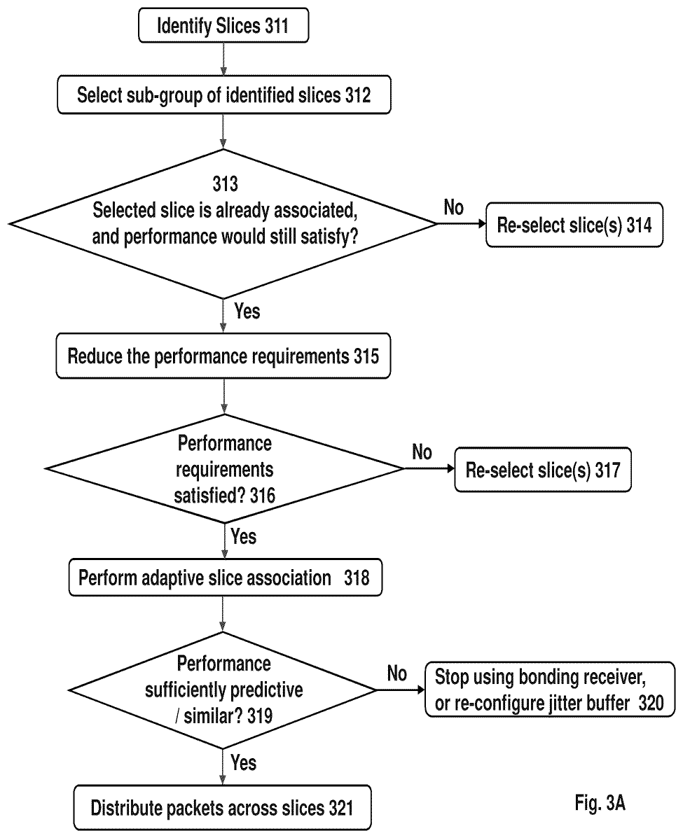

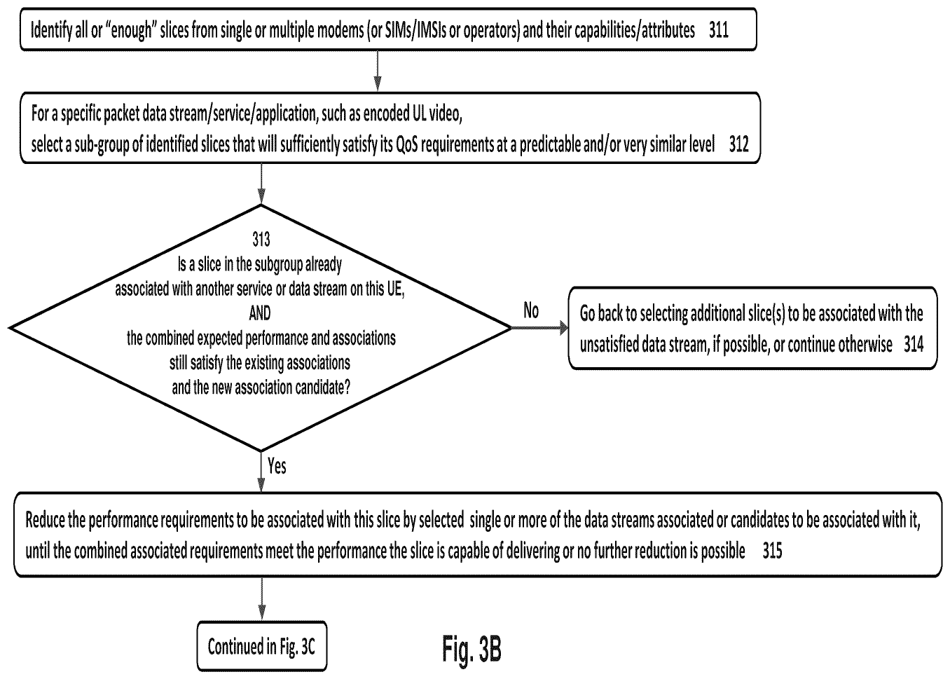

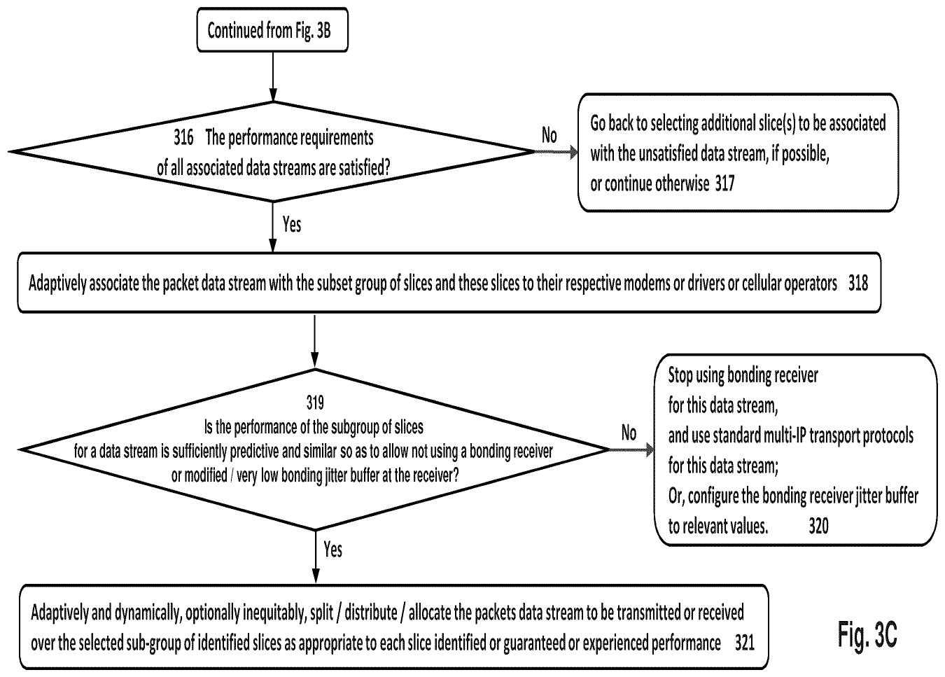

FIG. 3 demonstrates an algorithm flow or operational flow in the UE device. For example, the UE device (or application, or driver, or Operating System) identifies the available cellular slices from (or based on) their manifestation or publication by the single or multiple cellular operators or networks or cellular towers or other cellular nodes. It then selects them, and groups them, or may bin them together, according to their published or otherwise identified or expected or estimated or guaranteed (if relevant) or experienced performance characteristics; for example, based on a “guaranteed” UL bitrate or bandwidth, and/or “guaranteed” UL latency, and/or “guaranteed” reliability levels. Such selection and grouping of slices may be, for example, n1 slices of the same type and by the same cellular operator—each slice being used/associated/registered to by a different modem in or associated to the UE, or n2 slices from operator O1 and n3 slices from operator O2 where each slice is being used by or associated with one of the modems that are in the UE or that are operably associated with the UE, or any other combinations of slice types from one or more operators, networks, Radio Access Technologies (RATs), SIMs, eSIMs, vSIMs, IMSIs, or modems. The UE device or application/driver/OS then matches the performance requirements of one or more applications that need to send or receive data packets or data streams, to the available performance in the one or more of the slice groups or slice subsets. If the performance requirements are satisfied by one or more of the slice bins/groups, then this group or those groups are associated to that application, and the packets or data streams related to it will use this group where the bonding algorithm will split or distribute the packets over or across the relevant slices (namely, across the SIM, modem, network, RAT, operator with which each slice is associated with). Such splitting or packet distribution or packet allocation or packet assignment or may be done according to and in relation/ratio to the slice's expected/predicted/estimated/manifested attributes or performance characteristics, and/or according to the real or actual or measured performance that the bonding mechanism measures or is being reported about in real time or in near real time. For example, at cell edge (the perimeter coverage area of a certain network antenna or cell), the bandwidth may be less, or even significantly less, than the expected or published or “guaranteed” bandwidth or “goodput”. In accordance with some embodiments, FIG. 3 further demonstrates that a slice or a group of slices may be associated with a multiplicity of applications that consume or generate data streams; and hence when a new slice is identified and is being processed for “binning”/“grouping” or for being associated with applications, the overall performance requirements of all applications that are to be associated with this slice are validated. In such cases, the algorithm will attempt to ensure that the total performance requirements of all these applications is satisfied by the slice groups, and that the expected/planned load on each slice in the slice group will not exceed its published or identified or experienced performance. For example, when a slice is published to provide “guaranteed” uplink bandwidth of 10 Mbps, and for example three such slices are being binned or grouped or bonded (and in this specific example—these slices belong to the same operator and are registered to 3 different modems in this same bonding device), then the total UL bandwidth assigned to this group of slices as expected or experienced from one or more applications on that UE, will not exceed the 3×10=30 Mbps. Further, the bonding mechanism will avoid an over-loading of each of these slices with more than 10 Mbps. In accordance with some embodiment, FIG. 3 further demonstrates that if the performance in terms of one or more performance parameters (e.g., UL latency and/or UL goodput and/or UL loss rate or reliability level) of each of the slices in a slice-bin or a slice-group (each bin/group may contain one or more slices) is expected or manifested or experienced to be sufficiently reliable (e.g., beyond a pre-defined or dynamically-defined reliability level), then the bonding unit or mechanism may decide that no receiving/proxy bonding application is needed, and/or that no special bonded reception protocol is needed. Hence it may decide to use multi-path protocols such as MP-TCP or QUIC or others, which may send the packets directly to the receiving IP address/port/DNS/other recipient identifier or alias or pointer, without necessarily utilizing a “bonding” receiver entity or an assembly engine on the receiving side that otherwise would have a jitter buffer to accommodate the different and changing fluctuating latencies, communicate back with the transmitter bonding entity to report on performance and states, and re-assemble the packets that were distributed across multiple communication links and slices. This decision to not use a bonding receiver and protocols may change from session to session, and even during the same session, if the experienced performances change (e.g., due to the mobility of the UE device(s) involved). The steps demonstrated in FIG. 3 are demonstrative and non-mandatory, and are provided as examples for a possible flow of operations. Their order may also change. For example, instead of binning or grouping slices and matching the requirements of all applications to it, a certain type of high priority applications may be defined, and then slices are picked or selected form the identified/available slices in order to satisfy that application's performance requirements. Additionally or alternatively, in some embodiments, firstly the UE device may decide that for a certain application a serverless bonding is needed, and thus it will pick the cellular slice(s) that has or that have reliability level that is sufficient for establishing such serverless bonded communication in a sufficiently high predictability level, even if the total of their UL bandwidth does not satisfy the current requirement from that application; and it may later reduce the requirement (e.g., by tuning or re-configuring a video encoder to a lower output bandwidth or bitrate, such as lower resolution or Group-of-Pictures GOP structure or other video parameters), so to match the total UL bandwidth or throughput or goodput of that group of slices for this serverless bonding communication.

In some embodiments, the UE device may combine or fuse geo-location information with the cellular slices information. This data combination or fusion may be used by the UE device, and/or may be shared with a central entity or a remote server or with other UE devices (directly or indirectly), in real time in near real time or offline, so as to construct and to dynamically or periodically update a local or global geo-location map of cellular slices that are available from one or more network operators, with accompanying data describing the promised/guaranteed properties of each cellular slice and/or the actual/measured properties of each such cellular slice. Such a map can then be used for pre-planning and/or pre-ordering or pre-reserving of cellular slices or cellular infrastructure services relying on slices, for optimizing or improving the network coverage and slice performances by the relevant cellular operator(s).

Nested slices, or sub-slices, or parent-and child slices, or tiered cellular slicing:

In some embodiments, a new way of slice structure, architecture, management, allocation and usage is devised and may be utilized and/or supported. In some cellular slice architectures, each cellular slice is “parallel” to other slices, such that each slice is or associated with an instance of a resource that is allocated to it.

In accordance with some embodiments, an architecture of “nested slices” or “slices within a slice” or “tiered slices” or “tiered slicing” or “slice and sub-slices” may be constructed and/or deployed and utilized in a cellular communication network. In such architecture, one or more cellular communication slices may be nested within one or more other cellular slices, in one or more “layers” or “tiers” or “nesting levels” at any suitable “depth” of nesting or tiering and distribution and/or dynamicity of slices or cellular resource allocations amongst the sub-slices and/or nested tiers. Thus, a cellular communication slice, or other type of cellular communication infrastructure differentiated resource, is further “sliced” (e.g., via configuration/definitions) to sub-slices, allowing further differentiation and/or “binning” or “grouping” of specific UE devices/IMSIs/(c)UICCs/(e)SIMs with regard to selective utilization of such sub-slices or nested slices. In some embodiments, a common characteristic for all sub-slices with their parent slice is: having the same QoS level or QoE level or “guaranteed performance” (or promised, or committed, or allocated) per an IMSI/cellular modem/(e)UICC/(e)SIM/subscriber/cellular identifier cellular connection/link/session. The total resources that are associated with each cellular sub-slice, hence the “total performance” available within each cellular sub-slice, hence the number of sessions or identifiers simultaneously served by each cellular sub-slice, may differ from one sub-slice to another sub-slice, and may differ from the parent slice and the relevant child-slices or nested sub-slices.

For example, a super slice or a parent slice S1 is being allocated resources such that it “guarantees” 50 Mbps uplink for an authorized subscriber (or SIMs or IMSIs or any other identification or credentials that is associated with it). Within this parent slice or super slice, several “smaller bandwidth” or “partial bandwidth” cellular slices may be defined and deployed. For example, slice S1-s1 with up to 10 Mbps UL, and slice S1-s2 with up to 25 Mbps UL, and slice S1-s3 with up to 15 Mbps UL. The same or different set of SIMs or IMSIs or other credentials or contracts may be authorized for each such sub-slice or nested slice or “child slice” (of the “parent slice”). For example, a customer or contract C1 with a number n1 of IMSIs or SIMs may be authorized to use only the sub-slice S1-s1; whereas a customer or contract C2 with a number n2 of IMSIs or SIMs may be authorized to use all the sub-slices in S1; whereas a customer or contract C3 with a number n3 of IMSIs or SIMs may be authorized to use only the sub-slice S1-s2. Such structure of nested slices, or of a parent slice having several children slices, allows the cellular operator to define the parent slice S1 in a way that does not necessarily plan for the worst case of demands from all the three customers/contracts, which may exceed the total available resources of the super slice S1 as defined, but rather, to assume some statistical multiplexing or some long-term averaging or momentary averaging among actual usage of different customers as not all customers (and their devices) may require to utilize at the same time-point (or time-slot, or time-segment) the maximal bandwidth at the same (or near) geo-location or cell region. Also, this allows the customers of a cellular operator to use a pool of “guaranteed” bandwidth between several of their (c)SIMs/IMSIs/eUICC at each location served by that network. In this way, the customer may define it wants to “guarantee” for example 10 Mbps to be used together by any of its set of SIMs but not by others. This allows the “guaranteed” performance to not be defined (or enforced) per SIM, but rather per customer. If the customer has only one SIM at a certain location at a certain time, then that SIM will be able to use all the slice UL bandwidth (10 Mbps in this example). If the customer has and uses five SIMs in that location and at that time, then each of his authorized registered SIMs will be “guaranteed” up to 2 Mbps in this example. This “guaranteed” allocation may also change dynamically during a session if SIMs/IMSIs/UICCs/credentials join or leave the sub-slice or the super-slice, hence allowing less or more resources to be allocated for each remaining SIMs in the relevant sub-slice. In some embodiments, the maximum number of concurrent SIMs in a sub-slice may be defined or may be constrained via a threshold value (e.g., a threshold that allows each super-slice to be divided into not more than 8 sub-slices; a threshold that allows each sub-slice to be utilized by not more than 16 unique devices/SIMs/IMSIs. In some embodiments, the sub-slice availability and/or current status and/or other performance parameters may be manifested or published or notified to a relevant SIM or IMSI or UE device, by the network entities as part of an extension of the communication protocols or as part of a new standard or communication protocol. In some embodiments, at least one new function (or entity, or unit, or control unit) can be added to the cellular network infrastructure to manage the nested slicing, their allocation, a division of a super slice into nested slices, a unification of sub-slices or a deletion of a sub-slice in particular situations, and to manage the associated SIMs and contracts/subscribers and the adaptive real time or near real time allocation of network resources per the dynamic number of registered SIMs/IMSIs/UICCs/credentials per such nested slice(s).

In some embodiment, the bonding mechanism or unit or component in a UE device may be notified from the network manifestation, or by another source or may be pre-configured as to the availability of nested slices or sub-slices that are available to it and/or the status of the usage and/or operational properties (guaranteed and/or actual) of each such sub-slice. It may then selectively decide on its own, and/or be instructed to by a centralized entity or by a remote server that is associated with that contract or customer or subscriber, to register or to avoid registering or to un-register to a sub-slice, and/or to use or to avoid using a particular sub-slice to which it is already registered. For example, it may decide or may be instructed to use not more than 1 Mbps of uplink bandwidth on a particular sub-slice (or a particular slice), because it has sufficient uplink bandwidth from other sub-slices or slices (e.g., from other bonded modems associated with it) on that same or other cellular network.

In some embodiments, a super-slice or a parent slice is a “guaranteed minimum bandwidth” slice; and it is divided into a plurality of sub-slices or children slices, such that each sub-slice is a “guaranteed minimum bandwidth” sub-slice. In some embodiments, each sub-slice has the same “guaranteed minimum bandwidth” as each other sub-slice of the same parent slice; for example, dividing a 50 Mbps guaranteed uplink bandwidth parent slice, into five sub-slices, each of those five sub-slices having a 10 Mbps guaranteed uplink bandwidth. In other embodiments, two sub-slices of the same slice may be defined or constructed to have different values of guaranteed uplink bandwidth; for example, dividing a 50 Mbps guaranteed uplink bandwidth parent slice, into three sub-slices having (respectively) 10 and 15 and 25 Mbps guaranteed uplink bandwidth.

In some embodiments, a super-slice or a parent slice is a “guaranteed minimum bandwidth” slice; and it is divided into a plurality of sub-slices or children slices, such that each sub-slice is a “best effort” sub-slice. For example, a parent slice of 50 Mbps guaranteed uplink bandwidth, is divided into three sub-slices, each one having a “best effort” uplink bandwidth of 20 Mbps. Even though 3×20=60 Mbps, the three sub-slices may still provide adequate QoS to their UE devices, since not all the UE devices may utilize the entire bandwidth at every time-point, and since each sub-slice is defined as a “best effort” and not as a “guaranteed” bandwidth.

In some embodiments, a super-slice or a parent slice is a “guaranteed minimum bandwidth” slice; and it is divided into a plurality of sub-slices or children slices, such that one or more of the sub-slices are “best effort” sub-slice(s), and such that one or more other sub-slices of the same parent slice are “guaranteed minimum bandwidth” sub-slices. For example, a parent slice of 50 Mbps guaranteed uplink bandwidth, is divided into: a first sub-slice that has “guaranteed minimum bandwidth” of 20 Mbps; and four more sub-slices, each of them having a “best effort” uplink bandwidth of 10 Mbps.

In some embodiments, a super-slice or a parent slice is a “guaranteed maximum latency” slice; and it is divided into a plurality of sub-slices or children slices, such that each sub-slice is also “guaranteed maximum latency” sub-slice.

In some embodiments, a super-slice or a parent slice is a “guaranteed maximum latency” slice; and it is divided into a plurality of sub-slices or children slices, such that each sub-slice is a “latency not guaranteed” or “best effort latency” sub-slice.

In some embodiments, a super-slice or a parent slice is a “guaranteed maximum latency” slice; and it is divided into a plurality of sub-slices or children slices, that include: one or more sub-slices that are “guaranteed maximum latency” sub-slices, and one or more sub-slices that are “latency not guaranteed” or “best effort latency” sub-slice.

In some embodiments, a super-slice or a parent slice is a “best effort bandwidth” and/or “best effort latency” slice; and it is divided into a plurality of sub-slices or children slices, such that each sub-slice is a “best effort bandwidth” and/or “best effort latency” sub-slice.

In some embodiments, the transmitting device and/or the bonding component thereof may be associated with two or more sources of data, or two or more generators of data packets; and may utilize two (or more) cellular slices and/or cellular sub-slices for transmitting or uploading or up-streaming each data type that originated from each different source or generator.

In a demonstrative configuration, a single bonding unit or bonding engine may be associated with a plurality of cellular communication modems, denoted Modems M1 and M2 and M3 and M4. The bonding unit is associated with two sensors: an acoustic microphone that captures live audio and produces audio packets; and an optical imager or video camera that captures live video and produces video packets. One or more of these inputs may be digitized (Analog to Digital conversion), encoded or compressed by relevant encoders, and/or otherwise turned into data packets and/or IP encapsulated packets. The bonding unit checks which cellular slices and/or sub-slices are available, and checks what is the guaranteed and/or actual and/or estimated and/or measured and/or published and/or manifested performance characteristics of each such available slice and/or sub-slice.

In a first example, the bonding unit determines to allocate packets for uploading as follows: audio packets from the microphone (or from an associated audio processor or packetizer unit or packet-creating unit) will be uploaded exclusively by modem M1 via cellular slice SL1; and in parallel, video packets from the camera (or from an associated video processor or packetizer unit or packet-creating unit) will be uploaded exclusively by modem M2 via cellular slice SL2; and in parallel, FEC data will be uploaded exclusively by modem M3 via cellular slice SL3; and in parallel, metadata will be uploaded exclusively by modem M4 via slice SL4.

In a second example, the bonding unit determines to allocate packets for uploading as follows: audio packets from the microphone (or from an associated audio processor or packetizer unit or packet-creating unit or input stream) will be uploaded exclusively by modem M1 via cellular slice SL1; and in parallel, video packets from the camera (or from an associated video processor or packetizer unit or packet-creating unit) will be uploaded exclusively by modem M2 via cellular slice SL2; and in parallel, FEC data will be uploaded exclusively by modem M3 via cellular sub-slice SL3a which is a sub-slice of cellular slice SL3; and in parallel, metadata will be uploaded exclusively by modem M4 via cellular sub-slice SL3b which is another sub-slice of that cellular slice SL3.

In a third example, the bonding unit determines to allocate packets for uploading as follows: audio packets from the microphone (or from an associated audio processor) will be uploaded exclusively by modem M1 via sub-slice SL1a of cellular slice SL1; and in parallel, video packets from the camera (or from an associated video processor or packetizer unit or packet-creating unit) will be uploaded exclusively by modem M2 via cellular sub-slice SL2a of cellular slice SL2; and in parallel, FEC data will be uploaded exclusively by modem M3 via cellular sub-slice SL1b which is another sub-slice of the cellular slice SL1; and in parallel, metadata will be uploaded exclusively by modem M4 via cellular sub-slice SL2b which is another sub-slice of the cellular slice SL2.

In a fourth example, the bonding unit determines to allocate packets for uploading as follows: a single cellular modem M1 is utilized, and it uploads or transmits packets over four different cellular slices and/or sub-slices; for example, audio packets from the microphone (or from an associated audio processor or audio encoder or processor or packetizer unit or packet-creating unit) will be uploaded exclusively by cellular modem M1 via cellular slice SL1; and in parallel, video packets from the camera (or from an associated video processor or video encoder or processor or packetizer unit or packet-creating unit) will be uploaded exclusively by that same cellular modem M1 via cellular slice SL2; and in parallel, FEC data will be uploaded exclusively by that same modem M1 via cellular slice SL3; and in parallel, metadata will be uploaded exclusively by that same modem M1 via cellular slice SL4.

In a fifth example, the bonding unit determines to allocate packets for uploading as follows: a single cellular modem M1 is utilized, and it uploads or transmits packets over four different cellular slices and/or sub-slices; for example, audio packets from the microphone (or from an associated audio processor or audio encoder or processor or packetizer unit or packet-creating unit) will be uploaded exclusively by cellular modem M1 via cellular slice SL1; and in parallel, video packets from the camera (or from an associated video processor or video encoder or processor or packetizer unit or packet-creating unit) will be uploaded exclusively by that same cellular modem M1 via cellular slice SL2; and in parallel, FEC data will be uploaded exclusively by that same modem M1 via cellular sub-slice SL3a of cellular slice SL3; and in parallel, metadata will be uploaded exclusively by that same modem M1 via cellular sub-slice SL3b of cellular slice SL3.

In a sixth example, the bonding unit determines to allocate packets for uploading as follows: a single cellular modem M1 is utilized, and it uploads or transmits packets over four different cellular slices and/or sub-slices; for example, audio packets from the microphone (or from an associated audio processor or audio encoder or processor or packetizer unit or packet-creating unit) will be uploaded exclusively by cellular modem M1 via cellular sub-slice SL1a of cellular slice SL1; and in parallel, video packets from the camera (or from an associated video processor or video encoder or processor or packetizer unit or packet-creating unit) will be uploaded exclusively by that same cellular modem M1 via cellular sub-slice SL2a of cellular slice SL2; and in parallel, FEC data will be uploaded exclusively by that same modem M1 via cellular sub-slice SL1b of cellular slice SL1; and in parallel, metadata will be uploaded exclusively by that same modem M1 via cellular sub-slice SL2b of cellular slice SL2.

In a seventh example, the bonding unit determines to allocate packets for uploading as follows: two cellular modems (M1 and M2) are utilized in concert or in parallel or simultaneously, and they upload or transmit packets over four different cellular slices and/or sub-slices; for example, audio packets from the microphone (or from an associated audio processor or audio encoder or processor or packetizer unit or packet-creating unit) will be uploaded exclusively by cellular modem M1 via cellular sub-slice SL1a of cellular slice SL1; and in parallel, video packets from the camera (or from an associated video processor or video encoder or processor or packetizer unit or packet-creating unit) will be uploaded exclusively by that same cellular modem M1 via cellular sub-slice SL2a of cellular slice SL2; and in parallel, FEC data will be uploaded exclusively by modem M2 via cellular sub-slice SL1b of cellular slice SL1; and in parallel, metadata will be uploaded exclusively by that cellular modem M2 via cellular sub-slice SL2b of cellular slice SL2.

The above are non-limiting examples; and other combinations may be dynamically configured, constructed, modified and/or deployed by the bonding unit; by taking into account the momentary and/or estimated and/or predicted and/or advertised and/or manifested and/or published and/or actual and/or measured performance characteristics of each cellular slice and/or each cellular sub-slice; and/or by taking into account one or more QoS/QoE goals or constraints that are imposed or requested or enforced by a particular application (e.g., live video sharing or live video streaming; conference call; real time gaming) that may run on the UE device.

It is noted that portions of the discussion above that relate to selective “binning” or “grouping” of cellular slices, may similarly apply to, and enable: selective “binning” or “grouping” of cellular sub-slices that belong to the same parent slice. For example, a parent slice SL1 is divided into five sub-slices, denoted SL1a and SL1b and SL1c and SL1d and SL1e; and the bonding unit performs binning or grouping of three particular sub-slices (such as SL1a and SL1d and SL1e) into a particular bin or group.

It is noted that portions of the discussion above that relate to selective “binning” or “grouping” of cellular slices, may similarly apply to, and enable: selective “binning” or “grouping” of cellular sub-slices that belong to two or more different parent slices. For example, a first parent slice SL1 is divided into four sub-slices, denoted SL1a and SL1b and SL1c and SL1d and SL1e; and a second parent slice is divided into three sub-slices, denoted SL2a and SL2b and SL2c; and the bonding unit performs binning or grouping of three particular sub-slices (such as SL1a and SL2a and SL2c) into a particular bin or group.

It is noted that portions of the discussion above that relate to selective “binning” or “grouping” of cellular slices, may similarly apply to, and enable: selective “binning” or “grouping” of one or more cellular slices, with one or more cellular sub-slices. For example, a first parent slice SL1 (or other associated slice of differentiated cellular infrastructure resources) is divided into four sub-slices, not necessarily equal (in their total dedicated resources) but with the same QoS or “performance guarantee” for an IMSI/cellular modem/(c)UICC/SIM/eSIM/subscriber/identifier, denoted SL1a and SL1b and SL1c and SL1d and SL1e; and a second parent slice is divided into three sub-slices, denoted SL2a and SL2b and SL2c; and a third cellular slice SL3 remains undivided; and a fourth cellular slice SL4 remains undivided; and the bonding unit performs binning or grouping of three particular sub-slices (such as SL1a and SL2a and SL2c) and one undivided slice (such as SLA) into a particular bin or group.

Some embodiments may optionally utilize 3GPP or cellular data structures and mechanisms, such as URSP S-NSSAI or 5G QoS identifier (5QI), for gathering and using information about the available cellular slices/differentiated resources and the guaranteed, maximal, minimal and/or other characteristics of each, and hence structure or create or modify one or more groups of bonded sets of modems/transmitters/communication links/cellular links/subscribers/profiles/(c)SIMs/IMSIs/eUICC, and/or slices or sub-slices, on the same/single modem or on different modems, and/or using the same or multiple different networks.

Some embodiments may provide and perform a “single modem” bonding (or a single link/subscriber/IMSI/SIM/eSIM/vSIM bonding); by selectively utilizing two or more cellular slices (or sub-slices), having guaranteed performance and/or best effort/non-guaranteed performance, being authorized and/or allocated and/or associated and/or assigned and/or available to that particular single modem (or SIM/eSIM/vSIM/IMSI/subscriber/user profile/link).

Some embodiments may perform bonding of similarly performing differentiated resources (e.g., cellular slices or sub-slices) from multiple modems/subscribers/profiles/SIMs/cSIMs/vSIMs/IMSIs, and/or from multiple networks and/or technologies; for example: multiple similarly performing expected/guaranteed/notified/manifested slices (or sub-slices) from the same network and modem for the same subscriber/IMSI/(e)SIM; or as another example, multiple similar performing/expected/guaranteed/notified/manifested slices (or sub-slices) from several modems, each of which is associated with a different subscriber/IMSI/profile/(c)SIM yet being on the same network; or in another example: multiple similar performing/expected/guaranteed/notified/manifested slices (or sub-slices) from several modems, each of which is associated with a subscriber/IMSI/profile/(e)SIM and each of the multiplicity of slices (or sub-slices) possibly being from a different cellular network.

Some embodiments may utilize, or may even rely on, the guaranteed/notified/assumed/configured/manifested/published performance characteristics of the slice/link (or sub-slice) or multiplicity thereof being used by the bonding mechanism to aggregate bandwidth at a particular expected/guaranteed performance/QoS/QoE parameters such as UL or DL bandwidth and/or at maximal expected latency and/or reliability, and while also (one or more of): reducing the receiver jitter buffer size/length/time duration by having it set/configured “tighter” around the guaranteed performance at that time and location; reducing the FEC and/or other error correction or error prevention mechanisms and redundant sent packets; having a “tighter”/quicker/more accurate/expected/reliable degradation and ramp-up of the transmission due to the guaranteed/known performance.

Some embodiments may operate similarly, but without requiring the bonding component in the transmitter to mandate, nor to receive nor to rely on performance feedback about the links or to other perform operations for managing the transmission, hence: without requiring a sub-component for analyzing such feedback and controlling the transmission accordingly. Some embodiments may transmit data packets per modem or per slice (or per sub-slice) according to or in relation to the expected/guaranteed/manifested/advertised/notified/published performance characteristics associated with each such slice or sub-slice, without relying on actually-measured momentary performance characteristics or periodically-measured performance characteristics; and/or by taking into account the total or the absolute number of, or the changes in, the number or size or the packets that were not yet sent out, and/or by taking into account an estimated difference in the number of packets yet to be sent in view of the expected/guaranteed/manifested/advertised/notified/published performance of each slice (or sub-slice) or modem; without the need to utilize, or to rely on, a proprietary protocol for handshake with a receiving side; without needing a proprietary mechanism at the receiving side; but rather, by utilizing TCP or UDP based protocols.

In some embodiments, the same application on the same UE device, may differentiate packets of certain importance, qualities and/or characteristics among different slices or sub-slices, optionally in correlation to the slices' characteristics. For example, for a certain live audio-video stream, the encoded/compressed audio packets may be less important than the compressed video packets; therefore, the video packets are transmitted on a “guaranteed performance” slice, while the audio packets, or some of them (e.g., at least some of the audio samples) are sent on a “best effort” slice, or on a “guaranteed performance” slice that has a smaller guarantee. In another example, send FEC data or FEC packets are sent over a “best effort” slice or sub-slice or link, whereas the audio/video packets themselves are sent on one or more of the “guaranteed performance” slices or sub-slices.

In some demonstrative embodiments, a single application running on a single UE device, may utilize in parallel three different types of slices or sub-slices. For example, an audio-video conferencing application (similar to Zoom or Microsoft Teams or Google Meet) may send out audio packets and video packets and also enables textual chat among users. The video packets may be transmitted out via Modem M1 via a “guaranteed bandwidth” slice SL1 of 20 Mbps; and in parallel, the audio packets may be transmitted out via Modem M2 via a “guaranteed bandwidth” slice SL2 of 5 Mbps; and in parallel, the non-audio non-video data packets that represent text messages or attached files that the user of the UE device sends out to other participants, may be transmitted out via Modem M3 via a “best effort” slice SL3 having best effort non-guaranteed uplink bandwidth of 7 Mbps.

In some embodiments, packets that were already assigned or allocated by the bonding unit for transmission via a particular modem and/or cellular slice (or cellular sub-slice), may be shifted or re-routed or re-assigned or re-allocated, by the bonding unit, to another, different, modem or slice or sub-slice; or to two or more such modems or slices or sub-slices; based on dynamic changes in the actual/measured/advertised/expected/guaranteed/notified/manifested performance characteristics of the relevant slices or sub-slices; to enable off-loading or load balancing, and/or to improve redundancy or resilience of the transmission, and/or to accommodate a situation in which the UE device is moving (e.g., the user is walking, running, driving, flying, entering buildings or floors, exiting, changing elevation, or the like); and/or to further enable mitigating or reducing of problems with a particular slice or sub-slice, and/or to improve transmissions when the UE device moves from a first region (served by a first set of slices) to a second region (served by a second set of slices, which may be different from the first set of slices, or which may be partially overlapping with it).

Some embodiments may actively and/or pre-emptively reserve slices or sub-slices, for subsequent utilization; for example, by occupying them in part or in full and/or by releasing them for other modems/devices to occupy them in the same geo-location area, thus overcoming network congestion for several devices that are associated with one another by logical, commercial or physical relations (e.g., same broadcaster customer). The selective “release and occupy” or “release and reserve” process may be performed in a coordinated timing scheme among two or more such UE devices, or in accordance with a pre-defined timing scheme (e.g., UE-1 releases a particular cellular slice, or un-registers from it, at a pre-defined time point T1; and UE-2 registers to that particular cellular slice at time point T1, or at time point T1 plus one millisecond).

Some embodiments may optionally divide or split or distribute audio/video transmissions in a scalable way, according to the guaranteed/known/measured/advertised performance of each of the slices (or sub-slices); such that the more important portions of the scalable audio/video (that are sufficient for reconstruction/reassembly on the receiver side, such as the Coarse Video layer), are sent via a slice or slices having guaranteed bandwidth/reliability (or having a greater guaranteed bandwidth/reliability); whereas, parts which are utilized to enhance the quality of that video or audio, for example more color depth or higher resolutions (or the Fine Video layer), are sent via other slice or slices with less reliability or higher latency or lower bandwidth or higher jittery behavior or on “best effort” slice(s).

Some embodiments may be configured to overcome network traffic binding validation or network traffic type validation (e.g., the cellular network infrastructure checking that packets or traffic per slice are of a particular type, and not authorizing usage for other-than-specified type or types of traffic on that slice), by encapsulating packets into acceptable/authorized/validation-ready type of encapsulated packets or protocols, and in coordination with the receiving side which will then de-capsulate or de-encapsulate the packets from their encapsulated format to their non-encapsulated format; thereby “pretending” to transmit a different type of traffic (that is allowed) on that cellular slice (or sub-slice), to overcome such network traffic-type validation units.

In some embodiments, network components can monitor the usage, load and/or performance of cellular slices (or sub-slices, or other differentiated network resources); and adaptively, in real time or near real time or in a dynamic manner, may allocate (or remove) resources to existing slices, or may even remove or cancel complete slices, or may span-up or create additional slices (e.g., by turning on or activating additional communication links or routers or switches or hubs or relay nodes or load balancers or off-loading units). For example, the network node may sense that a particular cellular slice is getting too loaded (in absolute value or in relational value, optionally at a certain pace or rate, thereby reducing probability of guaranteed performance beyond a certain threshold or ratio or otherwise), then the network infrastructure may take spectrum segments or other resources from a “best effort” slice, even if there are users and/or traffic on it, and transfer/re-allocate/re-assign/shift such resources from the “best effort” slice to the “guaranteed performance/bandwidth/latency” slice(s) and/or to other existing slices, and/or to set or configure new slices if they are not yet set at that point in time. IN another example, such change is performed by taking away resources from a “guaranteed performance/bandwidth/latency” slice, which may not be utilized enough at that point in time and location, to any other slice (e.g. to another “guaranteed performance/bandwidth/latency” slice, or to a “best effort” slice).

It is noted that any portions of the discussion above, or any portion in the drawings, that relates to a cellular Slice, may similarly be applied or utilized (in some embodiments) with regard to a Sub-Slice, or with regard to a plurality of Slices, or with regard to a plurality of Sub-Slices (that belong to the same parent slice), or with regard to a plurality of Sub-Slices (that belong to two or more parent slices), or with regard to a bin or group of two or more Slices and/or two or more Sub-Slices.

Some embodiments may include and/or may utilize one or more of the systems and/or methods and/or steps and/or components that are depicted in any of the drawings.

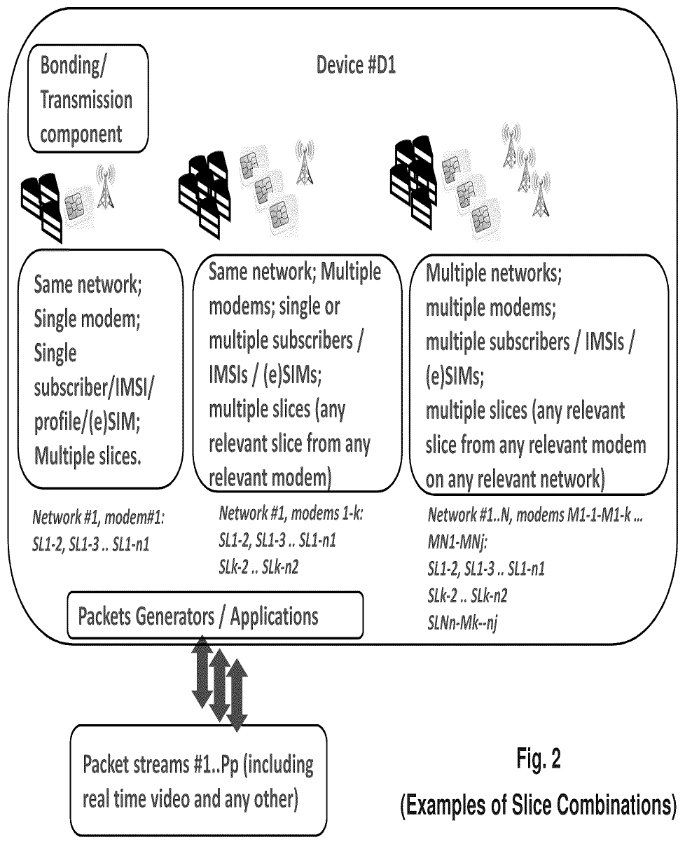

Referring to all the drawings, and particularly to the transmitting device shown in FIG. 1 and/or FIG. 2, it is clarified that the transmitting device (i) may transmit packets that were generated and/or prepared and/or packetized and/or encapsulated and/or encoded and/or compressed locally within the transmitting device and/or by an internal unit of the transmitting device and/or by an external component that is operably-associated with the transmitting device and/or by an external unit that is connected over a wire or cable or wireless communication link to the transmitting device, and/or (ii) may transmit packets that were received at the transmitting device from another device and/or from a co-located unit and/or from a remote unit and/or from a cable-connected unit (e.g., over a USB cable, over an HDMI cable, over a Serial Digital Interface (SDI) cable), and/or from an accessory device (e.g., a video camera, a video encoder unit, a video capturing unit) that may receive or may capture analog and/or digital video and/or that may prepare or generate or packetize or compress or encapsulate or encode packets or other discrete data-items or information units. Therefore, even if some drawing(s) show the transmitted packets as being received from an external source or as being generated by the transmitting device, these are non-limiting examples.

Reference is made to FIG. 1, which is a schematic block-diagram illustration of a communication network or a communication system 100, that may utilize dynamic/adaptive/selective bonding of cellular slices and/or cellular sub-slices (or nested slices), in accordance with some demonstrative embodiments. As stated, a “slice” may refer to any other differentiated resource or QoS allocation from the wireless or cellular network(s). It demonstrates a first Device (denoted D1), which may optionally utilize a plurality of internal and/or external modems/transmitters/transceivers/terminals. It receives data streams or signals from Audio/Video sources (such as one or more analog/SDI/HDMI/IP cameras or players or sensors or other sensors such as LIDARs or radars or others) and/or from external applications; it performs packetization of data to be transmitted or it may receive the streams from the external sources already packetized and hence not packetize them again; and it utilizes a Bonding/Transmission Component in concert with a Slice Exchange Coordinator and/or with a Slice Allocator & Management Unit. Other devices (denoted D2 to Dj) may similarly communicate within the system, via one or more wireless and especially cellular communication networks (e.g., network 1, network 2, through network k). Optionally, a slice exchange coordinator unit and/or a Slice Allocator & Management Unit may operate in the system, to configure and/or define and/or allocate and/or re-allocate slices and/or sub-slices and/or any other network-differentiated resource such as QoS level or performance assurance resources or spectrum or channel or others, to particular devices/modems/transceivers/subscribers/identity cards/virtual identity cards/credentials/applications or identified groups of such. Also shown is a recipient device having a receiver, optionally utilizing jitter buffer(s) whose size may be minimized or reduced, and a bonding receiving component to collect and/or re-assemble data or packets that were received over a plurality of bonded communication links; and such data or packets are utilized or consumed by packet-consuming application(s). The functions of D1 Slice Exchange Coordinator may be implemented inside the bonding component and/or in the modem(s) or in the UICC SIM card(s) and/or any combination of such. Note that the allocation or differentiated resources such as slices is done by the wireless/cellular network so the Slice Exchange Coordinator just coordinates, enables and manages this and its usage once allocated, from the device D1 side (or a specific modem, SIM, IMSI side).

In some embodiments, the cellular communication network may include one or more units or network elements or network functions that are responsible for bringing up/tearing down/setting/creation/definition/configuration/modification of cellular slices and/or cellular sub-slices; and/or for division of a cellular parent slice into a plurality of cellular sub-slices or child-slices; and/or for re-combining or unifying already-created sub-slices, and/or for discarding or replacing or modifying a sub-slices allocation structure; and/or for allocating or re-allocating a cellular slice or a cellular sub-slice to a particular or a group of transceiver/modem/SIM/eSIM/IMSI/subscriber account/subscriber profile, and/or for exchanging or swapping slices and/or sub-slices among two or more transceivers/modems/SIMs/eSIMs/IMSI/subscriber accounts/subscriber profiles/User Account Profile/UICC number or identifier; and/or for reserving and/or releasing cellular slices or sub-slices; and/or performing other operations related to slices and/or sub-slices as described above and/or herein. In some embodiments, the transmitting device may include a unit or module or component, that may request from the cellular communication network to obtain/release/reserve/allocate a cellular slice and/or a cellular sub-slice, in general and/or of a particular type (e.g., “best effort” type, “guaranteed minimum bandwidth” type, “guaranteed maximum latency” type, “guaranteed maximum error rate” type, or other types, or a combination of two or more types), and/or to request other modifications or re-allocation of slices or sub-slices. In accordance with some embodiments, the term “slice” or “cellular slice” (and similarly also “sub-slices” or “child slices” derived therefrom) may refer to any current or future “carving” or allocation or dedication or designation of network resources that may impact and/or differentiate the subscriber's (or IMSI, SIM, eSIM, vSIM, User Account Profile, etc.) Quality of Service (QOS) or Quality of Experience (QoE), such as, for example, a dedicated or shared spectrum or spectrum-portion or spectrum-band or spectrum-segment, time-slots or frequency slots or transmission codes in the physical transmission channel, carrier or carrier channels at the physical layer, transmission power levels at the physical layer, and/or any other resource at the physical layer, routing and/or paths at the IP level in the network or parts thereof, packets prioritization, bandwidth allocation at the IP layers, or any other resource allocation/designation/reserving/setting aside at the IP layer or network layers; such allocations may be in advance or at particular time-slots or times or days, and/or on demand (e.g., in response to a user device's request of “please allocate to me a cellular transmission link having characteristics X or Y”); and such communication links may be called differently than a “cellular slice”, and/or may be implemented using a different network mechanism for managing/defining/configuring/allocating them, and/or may have a different overall network impact and behavior than the formal “cellular slice” mechanisms; yet are another example of “differentiated QoS” or “assigned QoS” or “allocated QoS” or “designated QoS” or “carved QoS” or “guaranteed QOS” which may be selectively included/configured/defined/managed/allocated/reserved/released/re-allocated/exchanged/utilized in accordance with some embodiments.

Reference is made to FIG. 2, which is a schematic block-diagram illustration demonstrating several examples of combinations of bonded cellular slices and/or sub-slices (or nested slices), in accordance with some demonstrative embodiments. In a first demonstrative configuration, a single network is used, with a single transceiver or modem, and with a single subscriber/profile/SIM/eSIM/vSIM/IMSI/UICC identifier, yet with a plurality of slices and/or sub-slices. In a second demonstrative configuration, a single network is used, with a single transceiver or modem or with a plurality of transceivers or modems, and with a single subscriber/profile/SIM/eSIM/IMSI (or, with a plurality of subscribers/profiles/SIMs/eSIMs/vSIMs IMSIs/UICC identifiers), yet with a plurality of slices and/or sub-slices, with any relevant slice or sub-slice being associated with any relevant transceiver/modem. In a third demonstrative configuration, multiple networks are used, with a plurality of transceivers or modems, and with a plurality of subscribers/profiles/SIMs/eSIMs/IMSIs/UICC identifiers, and with a plurality of slices and/or sub-slices, with any relevant slice or sub-slice being associated with any relevant transceiver/modem and with any relevant network. Other suitable configurations may be used.

Some embodiments may utilize one or more cellular communication standards or protocols, such as 5G, and possibly future 6G or others, which may define or enable or deploy mechanisms that allow a single UE, or a single SIM or eSIM, or a single eUICC, or a single cellular modem, or a single IMSI, or a single cellular transceiver, to use multiple cellular resources or multiple cellular slices (or sub-slices, or nested slices) at the same time or concurrently or simultaneously. For example, some embodiments may utilize the 3GPP 5G standard, which defines a URSP mechanism (as defined in 3GPP TS 23.503 and/or elsewhere and/or differently in other embodiments of the present invention), slice information, slice policy information, slice association and slice usage selection, by which a cellular modem (or cellular transceiver, or other cellular communication element) can utilize (e.g., concurrently, simultaneously, in concert) multiple cellular slices that may be provided or defined by a cellular network at a certain location (or region, or area) and time-point (or time-slot, or time-segment). For example, a first cellular slice may have a first set of defined/guaranteed/promised/actual attributes or characteristics; whereas a second, different, cellular slice that is utilized concurrently by the same cellular modem or by the same cellular transceiver may have the same attributes or characteristics or conversely may have a second, different, set of defined/guaranteed/promised/actual attributes or characteristics (which may be completely different, or may be generally similar to the first set). Such multi-slice usage may be performed in 5G systems, for example as described in 3GPP TS 24.526, “5G User Equipment (UE) policies for 5G System (5GS); stage 3” for route selection; and may further define and/or utilize, for example, a traffic descriptor, a PDU session type or PDU session itself that may be associated via route selection process/procedure with one or more S-NSSAIs (Single Network Slice Selection Assistance Information), one or more DNNs (Data Network Name) and/or other parameters provided by the cellular communication network to describe its available infrastructure resources. The UE, application, cellular modem, cellular transceiver, SIM/eSIM applet or other cellular communication element may request to associate a particular PDU session, or a particular PDU session type, or a particular stream of data (at the application level), to a particular cellular slice represented by a particular set of parameters. For example, 3GPP may support transmission and transport of multiple streams (of the same type, or of multiple types; sent out by the same cellular modem or by the same cellular transceiver) over multiple cellular slices, communicating at the same time or in concert or in parallel; for example, to enable support for different requirements per different types of applications or stream, such as to differentiate the service for high-bandwidth video uplink streaming (or real-time gaming) versus low-bandwidth web browsing or versus car-to-network control communications, or other types of data streams or packet streams that may have different QoS or QoE requirements. Hence, either directly or implicitly, the bonding application or the bonding unit of some embodiments may represent itself to the cellular modem or to the cellular transceiver or to the cellular network in a way that will allow it to use multiple different cellular slices, concurrently or simultaneously. For example, but not exhaustively, the bonding application may use several different other proxy applications, or it may represent itself as having multiple different types of data applications and/or packet streams, or as having/generating multiple types of PDUs and/or multiple PDU sessions, or it may directly request to use multiple different streams or multiple different types of data streams, or it may associate itself with such multiple types of data streams via Operating System configuration or via a particular configuration by the cellular modem driver or modem AT commands (“come to attention commands”) or other interfaces. Therefore, the bonding mechanism or application may cause a single cellular modem/cellular transceiver/SIM/eSIM/cUICC/IMSI (or a single similar cellular communication unit) to use multiple cellular slices (and/or sub-slices) at the same time or in concert or concurrently or simultaneously.

In some embodiments, specific information, if known to the bonding application (including, as described above or herein, bonding of multiple cellular slices or other transmission-related or transport-related cellular resources on the same cellular modem/transceiver IMSI/cUICC/SIM/eSIM or similar cellular unit), can also be used. For example, the cellular network slice related policy control information, may include or may define limitation(s) of the data rate per network slice. The bonding application may access and may use such information in assessing or determining its bonding structure or scheme, statically and/or dynamically; such that, the bonding scheme and/or the slices utilization scheme (by a single modem/single transceiver) may take into account: the constrained/allowed/authorized transmission rate per specific slice or in the aggregate or in total, and/or margins from the actual transmission rates to the defined limitations per slice or in the aggregate, or other information that may be defined or published by the cellular network. In some embodiments, different types of slice-related information may be used in any suitable way as to impact or set or modify the bonded or single-resource transmission by a single cellular modem or by a plurality of cellular modems.

Reference is made to FIGS. 3A and 3B and 3C, which are a flow-chart of a demonstrative flow of operations of a method, in accordance with some demonstrative embodiments. FIG. 3A shows the flow-chart on a single page, with shorter textual labels within each block. FIGS. 3B and 3C shows the two halves of that single flow-chart, with more detailed textual labels within each block.

The demonstrative steps/blocks that are included in the demonstrative method of FIGS. 3A, 3B and 3C are:

Block 311: Identify all or “enough” slices from single or multiple modems (or SIMs/IMSIs or operators) and their capabilities/attributes.

Block 312: For a specific packet data stream/service/application, such as encoded UL video, select a sub-group of identified slices that will sufficiently satisfy its QoS requirements at a predictable and/or very similar level.

Block 313: check whether aa slice in the subgroup already associated with another service or data stream on this UE, and also, the combined expected performance and associations still satisfy the existing associations and the new association candidate.

If the checking result of Block 313 is negative, then go to Block 314: Go back to selecting additional slice(s) to be associated with the unsatisfied data stream, if possible, or continue otherwise.

If the checking result of Block 313 is positive, then proceed to Block 315.

Block 315: Reduce the performance requirements to be associated with this slice by selected single or more of the data streams associated or candidates to be associated with it, until the combined associated requirements meet the performance the slice is capable of delivering or no further reduction is possible.

Block 316: check whether the performance requirements of all associated data streams are satisfied.

If the checking result of Block 316 is negative, then go to Block 317: Go back to selecting additional slice(s) to be associated with the unsatisfied data stream, if possible, or continue otherwise.

If the checking result of Block 316 is positive, then proceed to Block 318.

Block 318: Adaptively associate the packet data stream with the subset group of slices and these slices to their respective modems or drivers or cellular operators.

Block 319: check whether the performance of the subgroup of slices for a data stream is sufficiently predictive and similar so as to allow not using a bonding receiver or modified/very low bonding jitter buffer at the receiver.

If the checking result of Block 319 is negative, then go to Block 320: Stop using bonding receiver for this data stream, and use standard multi-IP transport protocols for this data stream, or configure the bonding receiver jitter buffer to relevant values.

If the checking result of Block 319 is positive, then proceed to Block 321 and onward.

Block 321: Adaptively and dynamically, optionally inequitably, split/distribute/allocate/re-allocate the packets data stream (e.g., from a single particular application) to be transmitted or received over the selected sub-group of identified cellular slices (and/or sub-slices) as appropriate to each slice's identified or guaranteed or manifested or published or estimated or actually-experienced performance. In some embodiments, this may optionally include, later or subsequently, reserving/releasing of cellular slice(s) and/or cellular sub-slice(s), and/or the re-allocation of outgoing data packets to such cellular slice(s) and/or sub-slice(s), and performing other modifications to a packet distribution scheme with regard to the slices/sub-slices that are utilized for transmissions of different subsets of a set of outgoing packets of a single particular application.

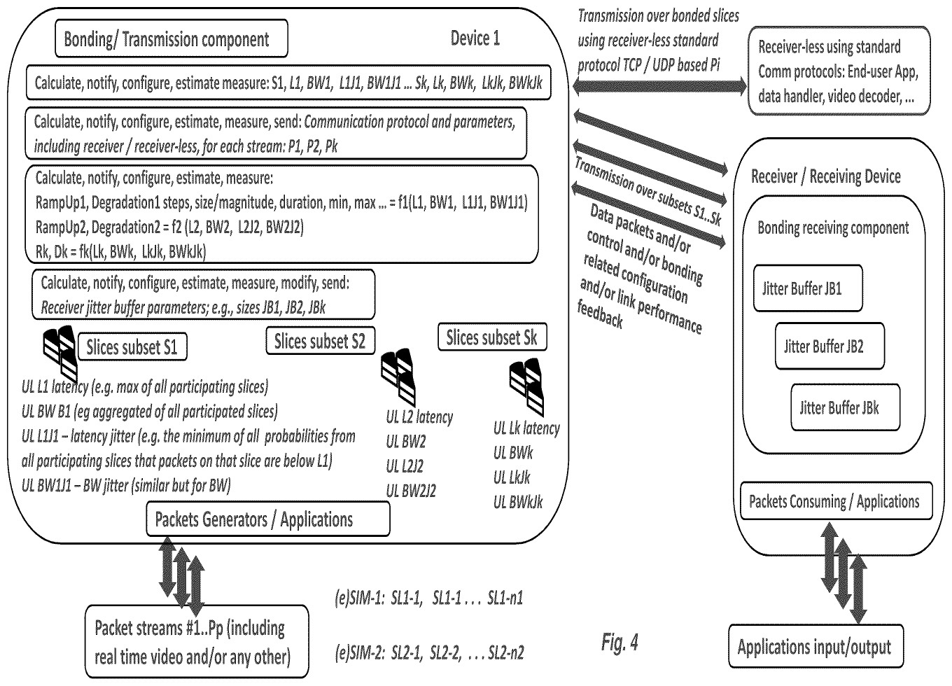

Reference is made to FIG. 4, which is a schematic illustration demonstrating some non-limiting examples of utilization of multiple cellular slices, in accordance with some demonstrative embodiments. In some embodiments, the receiving device or the recipient device may include a cellular receiver that is operably associated with a bonding component or a re-assembly engine, to enable the receiving device to arrange or re-arrange or re-order or otherwise combine or re-assemble, in an orderly manner, the incoming packet that may be incoming out-of-order yet in concert from a plurality of communication links and via a plurality of cellular slices and/or cellular sub-slices.

In accordance with some other embodiments, FIG. 4 indicates that optionally, a “receiver-less” system may be used; such that there is no need for a dedicated re-assembly proprietary bonding engine communicating back to the transmitter side at the receiving side, but rather, the cellular receiver (or receivers) on the side of the receiver device may utilize standard communication protocols, such as TCP or TCP/IP or UDP based, MP-TCP, QUIC or similar, to re-arrange the incoming packets in an orderly manner (e.g., based on packet serial numbers or other packet identifiers); accordingly, the term “receiver-less” does not mean that there is no receiver on the receiver side, but rather, that there is a conventional receiver that does not need to be modified or augmented with a proprietary mechanism in order to correctly re-assemble or re-arrange incoming packets to re-create on its side the original data stream(s) that was/were transmitted over the bonded communication links and over two or more cellular slices and/or cellular sub-slices or nested/tiered slices.

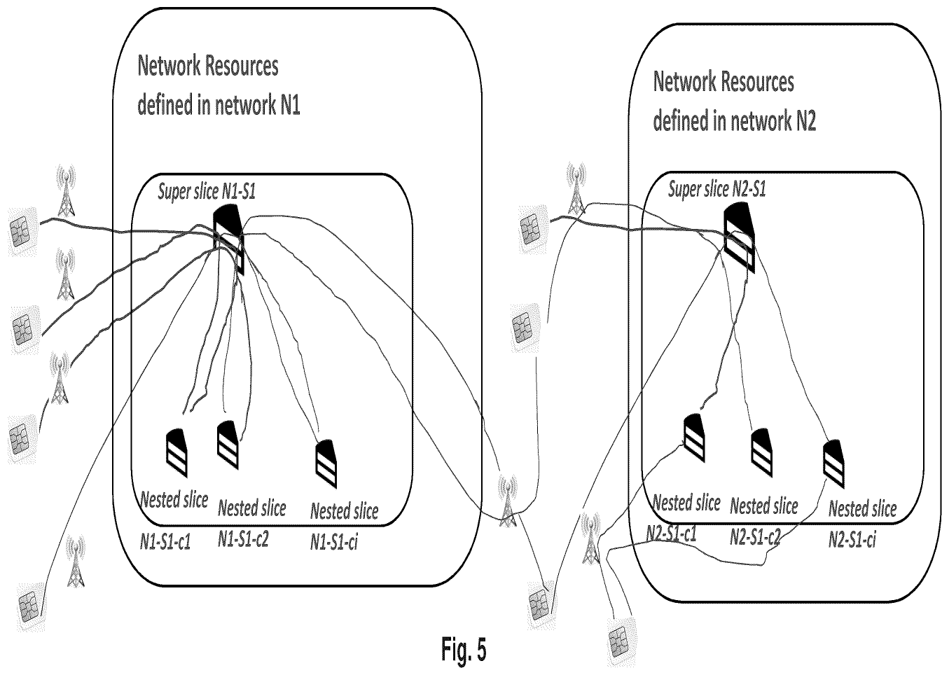

Reference is made to FIG. 5, which is a schematic illustration demonstrating nested slices and sub-slices, across two different cellular communication networks, in accordance with some demonstrative embodiments. In this demonstrative and non-limiting example, each cellular network has at least one parent-slice or super-slice. Each such super-slice has one or more child-slices or sub-slices; showing (for demonstrative purposes) three sub-slices for each of the two super-slices; showing (for demonstrative purposes) that the nesting levels (or tiered levels) are only single nesting or single-level nesting of slices (e.g., nesting tree depth of 2), yet each and/or all of the sub-slices may be further sliced into additional depth levels if desired. In some embodiments, SIMs (or eSIMs, or IMSIs, or cUICC, or cellular modems, or cellular transceivers, or other cellular units or cellular identifiers of cellular account profile or unique identifier), may optionally be connected to and/or may optionally utilize one sub-slice, or a plurality of sub-slices, or a combination of two or more slices and/or sub-slices from the same cellular network or from two (or more) cellular network, in concert or in parallel or concurrently; via the relevant super-slice/parent-slice, and/or directly if the sub-slices are published independently by the cellular network, using one or more of such sub-slices as part of a bonded communication channel. Two or more of such cellular subscribers may belong to the same pool, or owner, or billable entity or similar entity.

Some embodiments of the present invention may optionally be utilized in conjunction with a variety of configurations, with the following Table showing only a few of such non-limiting examples. In the following Table, the term “Slice” may be (in some implementations) a cellular sub-slice of a cellular parent slice or another form of differentiate/designated/carved QoS resources. In the following table, the term “Modem” may be a transceiver, or a SIM/eSIM/IMSI/Subscriber profile/UICC identifier. The term “No Slice” in some rows indicates that the bonded or aggregated communication link utilizes conventional transmission over cellular 5G (or 4G, or 4G LTE, or 3G, or 2G, or 6G, or other cellular communication standard(s) or protocol(s), without being allocated a particular cellular slice. Various other combinations may be used. It is clarified that the term “N/A” in some rows, under the modem or network columns, means that the respective modem or network are not applicable or are not used in that row combination; for example, in combination #1, both Slice 1 and Slice 2 are transmitted via the same Modem (M1), over the same Network (N1), and therefore an additional modem is not needed and is marked as “N/A” in that row, and similarly an additional network is not needed as is marked as “N/A” in that row.

| | | | Modem & | Modem & | | |
|---|---|---|---|---|---|---|
| | | | Identifier | Identifier | Network | Network |
| | Slice #1 | Slice #2 | #1 | #2 | #1 | #2 |
| 1 | Slice S1 | Slice S2 | M1 | N/A | N1 | N/A |
| 2 | Slice S1 | Slice S1 | M1 | M2 | N1 | N1 |
| 3 | Slice S1 | Slice S2 | M1 | M2 | N1 | N1 |
| 4 | Slice S1 | Slice S1 | M1 | M2 | N1 | N2 |
| 5 | Slice S1 | Slice S2 | M1 | M2 | N1 | N2 |
| 6 | Slice S1 | No slice | M1 | M2 | N1 | N1 |
| 7 | Slice S1 | No slice | M1 | M2 | N1 | N2 |
| 8 | Slice S1 | No slice | M1 | N/A | N1 | N/A |

Some embodiments of the present invention may utilize, or may comprise, or may operate in conjunction with, one or more devices or systems or methods that are described in patent number U.S. Pat. No. 7,948,933, which is hereby incorporated by reference in its entirety; and/or in U.S. Pat. No. 9,369,921, which is hereby incorporated by reference in its entirety; and/or in patent number U.S. Pat. No. 10,206,143, which is hereby incorporated by reference; and/or in U.S. Pat. No. 9,712,267, which is hereby incorporated by reference; and/or in patent number U.S. Pat. No. 9,154,247, which is hereby incorporated by reference; and/or with other suitable mechanisms or components for network assisted bonding, remote management of Quality of Service (QOS) between or among multiple bonding transmission devices, or other methods or units.

Some embodiments provide a system comprising: a cellular transmitting device, configured to transmit to a recipient device, via at least a first associated transmitter, a set of outgoing packets that belong to a first single application. The cellular transmitting device comprises a Bonding Unit that is configured to allocate, at an application level or at an Internet Protocol (IP) level: (I) a first subset of said outgoing packets of said single application, for transmission from said cellular transmitting device over a first communication link that utilizes a first cellular slice of a first cellular communication network; wherein said first communication link that utilizes said first cellular slice is associated with a first Cellular Identity Profile and with a first set of Quality-of-Service (QOS) parameters; wherein said first set of QoS parameters for said first cellular slice is manifested by said first cellular communication network; and (II) a second subset of said outgoing packets of said single application, for simultaneous transmission from said cellular transmitting device over a second communication link that utilizes a second cellular slice of said first cellular communication network; wherein said second communication link that utilizes said second cellular slice is associated with said first Cellular Identity Profile and with a second set of QoS parameters. The cellular transmitting device is associated with (or exactly with; or at least with) a first cellular transceiver, that is configured to transmit said first subset of said outgoing packets of said first single application via said first cellular slice, and is further configured to simultaneously transmit said second subset of said outgoing packets of said first single application via said second cellular slice.

In some embodiments, said second set of QoS parameters for said second cellular slice is manifested by said first cellular communication network.

In some embodiments, the Bonding Unit of said cellular transmitting device is configured to further allocate, at the application level or at the Internet Protocol (IP) level: a third subset of said outgoing packets of said single application for transmission from said cellular transmitting device over a third communication link that utilizes a third cellular slice of a second cellular communication network that is different from said first cellular communication network. The third communication link, that utilizes said third cellular slice, is associated with a second, different, Cellular Identity Profile and with a third set of QoS parameters; wherein said third set of QoS parameters for said third cellular slice is manifested by said second cellular communication network; wherein said Bonding Unit allocates zero or more packets into said second subset of outgoing packets for transmission via the second cellular slice; wherein transmission of the first subset of outgoing packets is performed via said first cellular transceiver that is associated with said first Cellular Identity Profile; wherein transmission of the third subset of outgoing packets is performed, simultaneously, via a second cellular transceiver that is associated with said second Cellular Identity Profile.

In some embodiments, each Cellular Identity Profile that is utilized by said cellular transmitting device, is defined by one of: a unique Subscriber Identity Module (SIM), a unique Embedded SIM (eSIM), a unique Virtual SIM (vSIM), a unique International Mobile Subscriber Identity (IMSI) number, a unique Universal Integrated Circuit Card (UICC), a subscriber Profile ID.

In some embodiments, said first cellular network and said second cellular network are two different cellular communication networks that are associated with two different cellular service providers.

In some embodiments, said first cellular network and said second cellular network are a same single cellular communication network that is associated with a same single cellular service provider; wherein the first cellular transmitter utilizes the first and the second cellular slices of said single cellular communication network; wherein the second cellular transmitter utilizes the third cellular slice of said single cellular communication network.

In some embodiments, at least some packets of said set of outgoing packets of said single application, are transmitted from said cellular transmitting device to said recipient device over said first cellular slice which is associated with a published guaranteed minimum bandwidth; wherein at least some other packets of said set of outgoing packets of said single application, are transmitted from said cellular transmitting device to said recipient device over said second cellular slice which is a cellular slice that does not have a published guaranteed minimum bandwidth and that operates on a best effort basis.

In some embodiments, the Bonding Unit is configured to allocate the first subset of outgoing packets of said single application for transmission via the first cellular slice, and to allocate the second subset of outgoing packets of said single application for transmission via the second, different, cellular slice; based on a cellular slices allocation scheme that takes into account at least one of: published minimum bandwidth of each cellular slice, expected bandwidth of each cellular slice, estimated latency of each cellular slice, estimated error rate of each cellular slice.

In some embodiments, said set of outgoing packets of said single application comprise at least two packet-types from the group consisting of: video packets, audio packets, data packets, error correction packets, control packets. Packets of a first type from said group, of said single application, are transmitted from said cellular transmitting device to said recipient device over the first cellular slice. Packets of a second, different, type from said group, of said single application, are transmitted from said cellular transmitting device to said recipient device over the second, different, cellular slice.

In some embodiments, said first cellular slice and said second cellular slice are specifically selected from a pool of available cellular slices, based on having sufficiently similar performance characteristics beyond a pre-defined threshold level of similarity.

In some embodiments, said first cellular slice and said second cellular slice are specifically selected from a pool of available cellular slices by using a cellular slices allocation scheme that is configured to create a bonded virtual communication link having bandwidth and transmission characteristics that are sufficient for timely and correctly delivering said set of outgoing data packets of said single application from said cellular transmitting device to said recipient device; wherein said bonded virtual communication link is comprised of a plurality of different cellular slices of at least one cellular communication network.

In some embodiments, based on characteristics of said bonded virtual communication link, one or more of the following modifications are performed: (a) one or more Forward Error Correction (FEC) parameters are adjusted by the cellular transmitting device; (b) a size of a Packet Reception Jitter Buffer is modified at said recipient device; (c) one or more Video Encoding parameters are adjusted at a video encoder that is associated with said cellular transmitting device.

In some embodiments, said first cellular slice and said second cellular slice are specifically selected from a pool of available cellular slices by using a cellular slices allocation scheme that is configured to create a bonded virtual communication link having particular values of bandwidth and transmission characteristics for delivering said set of outgoing data packets of said single application from said cellular transmitting device to said recipient device; wherein said bonded virtual communication link is comprised of a plurality of different cellular slices of at least one cellular communication network; wherein, based on characteristics of said bonded virtual communication link, one or more of the following modifications are performed: (a) one or more Forward Error Correction (FEC) parameters are adjusted by the cellular transmitting device; (b) a size of a Packet Reception Jitter Buffer is modified at said recipient device; (c) one or more Video Encoding parameters are adjusted at a video encoder that is associated with said cellular transmitting device.

In some embodiments, the cellular transmitting device is configured to estimate that in view of particular performance characteristics of the first cellular slice, a size of a Packet Reception Jitter Buffer at the recipient device can be reduced; and is configured to send a signal that indicates to the recipient device to reduce accordingly the size of its Packet Reception Jitter Buffer.

In some embodiments, the cellular transmitting device is configured to estimate that in view of particular performance characteristics of the first cellular slice, a size of a Packet Reception Jitter Buffer at the recipient device can be entirely eliminated; and is configured to send a signal that indicates to the cellular device to entirely de-activate said Packet Reception Jitter Buffer.

In some embodiments, the recipient device comprises: one or more receivers, configured to receive incoming packets from said cellular transmitting device; a receiver-side Reception Jitter Buffer Size Modification Unit, (a) configured to define a first Packet Reception Jitter Buffer for receiving incoming packets that are received for said single application via said first cellular slice, and (b) configured to define a second, separate, Packet Reception Jitter Buffer for receiving incoming packets that are received for said single application via said second cellular slice; wherein the receiver-side Reception Jitter Buffer Size Modification Unit is configured to dynamically modify a size of at least one of: the first Packet Reception Jitter Buffer, the second Packet Reception Jitter Buffer, based on a Jitter Buffer Size Modification Signal that is received at the recipient device from the cellular transmitting device; wherein said Jitter Buffer Size Modification Signal is generated by the cellular transmitting device based on at least one of: (i) a signal from performance characteristics of the first cellular slice that is used by the cellular transmitting device, (ii) performance characteristics of the second cellular slice that is used by the cellular transmitting device.

In some embodiments, at least the first cellular slice is: a cellular sub-slice of a parent cellular slice that was divided by a cellular network element or network function into at least two cellular sub-slices.

In some embodiments, the first cellular slice is a first cellular sub-slice of a parent cellular slice that was divided by a cellular network element/network function into at least two cellular sub-slices; wherein the second cellular slice is a second cellular sub-slice of said same parent cellular slice that was divided by the cellular network element/network function into at least two cellular sub-slices.

In some embodiments, the first cellular slice is: a first cellular sub-slice of a first parent cellular slice that was divided by a cellular network element/network function into a plurality of cellular sub-slices; wherein the second cellular slice is: a second cellular sub-slice of a second, different, parent cellular slice that was divided by the cellular network element/network function into a plurality of cellular sub-slices.

In some embodiments, the first cellular slice is: a first cellular sub-slice of a first parent cellular slice that was divided by a cellular network element/network function into a plurality of cellular sub-slices; wherein said first cellular sub-slice is associated with a published minimum bandwidth; wherein the second cellular slice is: a second cellular sub-slice of a second, different, parent cellular slice that was divided by the cellular network element/network function into a plurality of cellular sub-slices; wherein said second cellular sub-slice is not associated with a published minimum bandwidth and is operated on a best effort basis.

In some embodiments, at least one cellular sub-slice, of a group of sub-slices that were divided from the same single cellular parent slice, is initially allocated to a first Customer Identity Profile that is utilized by said cellular transmitting device; wherein said at least one cellular sub-slice, is subsequently released from being allocated to said first Customer Identity Profile, and is re-allocated, based on one or more sub-slices release and re-allocation rules, to the second Customer Identity Profile.

In some embodiments, the Bonding Unit of the cellular transmitting device is configured to distribute the outgoing packets for transmission over at least two different communication routes from the following group: a first cellular slice; a second, different, cellular slice; a Wi-Fi communication link.

In some embodiments, the Bonding Unit of the cellular transmitting device is configured to distribute the outgoing packets for transmission over at least two different communication routes from the following group: a first cellular sub-slice of a parent cellular slice; a second, different, cellular sub-slice of said parent cellular slice; a Wi-Fi communication link.

In some embodiments, the Bonding Unit of the cellular transmitting device is configured to distribute the outgoing packets for transmission over at least two different communication routes from the following group: a first cellular sub-slice of a first parent cellular slice; a second cellular sub-slice of a second, different, parent cellular slice; a Wi-Fi communication link.

In some embodiments, the first cellular slice is one of: (a) a first network-defined cellular slice that is carved and manifested by the cellular communication network; (b) a cellular communication link that has a first network-defined differentiated set of Quality of Service (Qos) parameters defined by the cellular communication network; wherein the second cellular slice is one of: (A) a second network-defined cellular slice that is carved and manifested by the cellular communication network; (B) a cellular communication link that has a second network-defined differentiated set of Quality of Service (QOS) parameters defined by the cellular communication network.

In some embodiments, the cellular transmitting device is configured to overwrite a value of at least one Transmission Control Protocol (TCP) parameter, of a TCP-based wireless routing of the said first single application, wherein said first single application is utilizing TCP; based on estimated or expected performance characteristics of at least one of: the first cellular slice, the second cellular slice.

In some embodiments, said set of outgoing packets comprise video content of said single application; wherein said video content is encoded to include: (i) a base-quality encoded video layer packets and (ii) a higher-quality encoded video layer packets; wherein the base-quality encoded video layer packets are transmitted from said cellular transmitting device to said recipient device over the first cellular slice; wherein the higher-quality encoded video layer packets are transmitted from said cellular transmitting device to said recipient device over the second, different, cellular slice.

In some embodiments, said set of outgoing packets comprise (i) encoded video packets, and (ii) error correction data, that correspond to the same video content; wherein the encoded video packets are transmitted from said cellular transmitting device to said recipient device over the first cellular slice; wherein error correction data is transmitted from said cellular transmitting device to said recipient device over the second, different, cellular slice.

Some embodiments provide a method for transmitting a group of outgoing data packets of a first single or particular application, from a cellular transmitting device to a recipient device. The method may comprise: allocating in said cellular transmitting device, at an application level or at an Internet Protocol (IP) level, (I) a first subset of said outgoing packets of said single application for transmission from said cellular transmitting device over a first communication link that utilizes a first cellular slice of a first cellular communication network, wherein said first communication link that utilizes said first cellular slice is associated with a first Cellular Identity Profile and with a first set of Quality-of-Service (QOS) parameters, wherein said first set of QoS parameters for said first cellular slice is manifested by said first cellular communication network; and (II) a second subset of said outgoing packets of said single application for transmission from said cellular transmitting device over a second communication link that utilizes a second cellular slice of said first cellular communication network; wherein said second communication link that utilizes said second cellular slice is associated with said first Cellular Identity Profile and with a second set of QoS parameters; wherein said cellular transmitting device is associated with a first cellular transceiver, that is configured to transmit said first subset of said outgoing packets via said first cellular slice, and is further configured to simultaneously transmit said second subset of said outgoing packets via said second cellular slice.

Some embodiments provide a system comprising: a cellular transmitting device, configured to transmit, using at least a first associated transmitter, to a recipient device a set of outgoing packets that belong to a first single application; wherein the cellular transmitting device comprises a Bonding Unit that is configured to allocate, at an application level or at an Internet Protocol (IP) level, (I)a first subset of said outgoing packets of said single application for transmission from said cellular transmitting device over a first communication link that utilizes a first cellular slice of a first cellular communication network, wherein said first cellular slice is associated with a first Cellular Identity Profile and with a first set of Quality-of-Service (QOS) parameters, and (II) a second subset of said outgoing packets of said single application for simultaneous transmission from said cellular transmitting device over a second communication link of said first cellular communication network; wherein said second communication link is associated with said first Cellular Identity Profile and with a second set of QoS parameters; wherein said cellular transmitting device (I) is associated with a first cellular transceiver, that is configured to transmit said first subset of said outgoing packets via said first cellular communication link that utilizes said first cellular slice, and (II) is further configured to simultaneously transmit said second subset of said outgoing packets via said second cellular communication link.

In some embodiments, said second communication link is associated with a second cellular slice that is associated with a second set of QoS parameters, and wherein said second cellular slice is manifested by said first cellular communication network.

In some embodiments, the Bonding Unit of said cellular transmitting device is configured to further allocate, at the application level or at the Internet Protocol (IP) level: a third subset of said outgoing packets of said single application for transmission from said cellular transmitting device over a third communication link that utilizes a third cellular slice of a second cellular communication network that is different from said first cellular communication network; wherein said third communication link, that utilizes said third cellular slice, is associated with a second, different, Cellular Identity Profile and with a third set of QoS parameters; wherein said third set of QoS parameters for said third cellular slice is manifested by said second cellular communication network; wherein said Bonding Unit allocates zero or more packets into said second subset of outgoing packets for transmission via the second cellular communication link; wherein transmission of the first subset of outgoing packets is performed via said first cellular transceiver that is associated with said first Cellular Identity Profile; wherein transmission of the third subset of outgoing packets is performed, simultaneously, via a second cellular transceiver that is associated with said second Cellular Identity Profile.

In some embodiments, each Cellular Identity Profile that is utilized by said cellular transmitting device, is defined by one of: a unique Subscriber Identity Module (SIM), a unique Embedded SIM (eSIM), a unique Virtual SIM (vSIM), a unique International Mobile Subscriber Identity (IMSI) number, a unique Universal Integrated Circuit Card (UICC), a subscriber Profile ID.

In some embodiments, at least some packets of said set of outgoing packets of said single application, are transmitted from said cellular transmitting device to said recipient device over said first cellular slice which is associated with a published guaranteed minimum bandwidth; wherein at least some other packets of said set of outgoing packets of said single application, are transmitted from said cellular transmitting device to said recipient device over said second cellular communication link which is a cellular communication link that does not have a published guaranteed minimum bandwidth and that operates on a best effort basis.

In some embodiments, the Bonding Unit is configured to allocate the first subset of outgoing packets of said single application for transmission via the first cellular slice, and to allocate the second subset of outgoing packets of said single application for transmission via the second, different, cellular communication link, based on a cellular slices allocation scheme that takes into account at least one of: published minimum bandwidth of each cellular slice, expected bandwidth of each cellular slice, estimated latency of each cellular slice, estimated error rate of each cellular slice.

In some embodiments, said set of outgoing packets of said single application comprise at least two packet-types from the group consisting of: video packets, audio packets, data packets, error correction packets, control packets; wherein packets of a first type from said group, of said single application, are transmitted from said cellular transmitting device to said recipient device over the first cellular slice; wherein packets of a second, different, type from said group, of said single application, are transmitted from said cellular transmitting device to said recipient device over the second, different, cellular communication link.

In some embodiments, said first cellular slice and said third cellular slice are specifically selected from a pool of available cellular slices, based on having sufficiently similar performance characteristics beyond a pre-defined threshold level of similarity.

In some embodiments, said first cellular slice and said third cellular slice are specifically selected from a pool of available cellular slices by using a cellular slices allocation scheme that is configured to create a bonded virtual communication link having bandwidth and transmission characteristics that are sufficient for timely and correctly delivering said set of outgoing data packets of said single application from said cellular transmitting device to said recipient device; wherein said bonded virtual communication link is comprised of a plurality of different cellular slices of at least one cellular communication network.

In some embodiments, based on characteristics of said bonded virtual communication link, one or more of the following modifications are performed: (a) one or more Forward Error Correction (FEC) parameters are adjusted by the cellular transmitting device; (b) a size of a Packet Reception Jitter Buffer is modified at said recipient device; (c) one or more Video Encoding parameters are adjusted at a video encoder that is associated with said cellular transmitting device.

In some embodiments, the cellular transmitting device is configured to estimate that in view of particular performance characteristics of the first cellular slice, a size of a Packet Reception Jitter Buffer at the recipient device can be reduced; and is configured to send a signal that indicates to the recipient device to reduce accordingly the size of its Packet Reception Jitter Buffer.

In some embodiments, wherein the recipient device comprises: one or more receivers, configured to receive incoming packets from said cellular transmitting device; a receiver-side Reception Jitter Buffer Size Modification Unit, (a) configured to define a first Packet Reception Jitter Buffer for receiving incoming packets that are received for said single application via said first cellular slice, and (b) configured to define a second, separate, Packet Reception Jitter Buffer for receiving incoming packets that are received for said single application via said third cellular slice; wherein the receiver-side Reception Jitter Buffer Size Modification Unit is configured to dynamically modify a size of at least one of: the first Packet Reception Jitter Buffer, the second Packet Reception Jitter Buffer, based on a Jitter Buffer Size Modification Signal that is received at the recipient device from the cellular transmitting device; wherein said Jitter Buffer Size Modification Signal is generated by the cellular transmitting device based on at least one of: (i) a signal from performance characteristics of the first cellular slice that is used by the cellular transmitting device, (ii) performance characteristics of the third cellular slice that is used by the cellular transmitting device.

In some embodiments, at least the first cellular slice is: a cellular sub-slice of a parent cellular slice that was divided by a cellular network element/network function into at least two cellular sub-slices.

In some embodiments, the first cellular slice is: a first cellular sub-slice of a first parent cellular slice that was divided by a cellular network element/network function into a plurality of cellular sub-slices; wherein the third cellular slice is: a second cellular sub-slice of a second, different, parent cellular slice that was divided by the cellular network element/network function into a plurality of cellular sub-slices.

In some embodiments, wherein the first cellular slice is: a first cellular sub-slice of a first parent cellular slice that was divided by a cellular network element/network function into a plurality of cellular sub-slices; wherein said first cellular sub-slice is associated with a published minimum bandwidth; wherein the third cellular slice is: a second cellular sub-slice of a second, different, parent cellular slice that was divided by the cellular network element/network function into a plurality of cellular sub-slices; wherein said third cellular sub-slice is not associated with a published minimum bandwidth and is operated on a best effort basis.

In some embodiments, at least one cellular sub-slice, of a group of sub-slices that were divided from the same single cellular parent slice, is initially allocated to a first Customer Identity Profile that is utilized by said cellular transmitting device; wherein said at least one cellular sub-slice, is subsequently released from being allocated to said first Customer Identity Profile, and is re-allocated, based on one or more sub-slices release and re-allocation rules, to the second Customer Identity Profile.

In some embodiments, the Bonding Unit of the cellular transmitting device is configured to distribute the outgoing packets for transmission over at least two different communication routes from the following group: a first cellular slice; a second, different, cellular slice; a Wi-Fi communication link.

In some embodiments, the Bonding Unit of the cellular transmitting device is configured to distribute the outgoing packets for transmission over at least two different communication routes from the following group: a first cellular sub-slice of a parent cellular slice; a second, different, cellular sub-slice of said parent cellular slice; a Wi-Fi communication link.

In some embodiments, the first cellular slice is one of: (a) a first network-defined cellular slice that is manifested by the first cellular communication network; (b) a first differentiated set of QoS parameters that is defined by said first cellular communication network to be associated with said first cellular communication link via said first Cellular Identity Profile; wherein the third cellular slice is one of: (a) a second network-defined cellular slice that is manifested by the first cellular communication network; (b) a second differentiated set of QoS parameters that is defined by said first cellular communication network to be associated with said third cellular communication link via said second Cellular Identity Profile.

In some embodiments, the cellular transmitting device is configured to overwrite a value of at least one Transmission Control Protocol (TCP) parameter, of a TCP-based wireless routing of the said first single application, wherein said first single application is utilizing TCP, based on estimated or expected performance characteristics of the first cellular slice.

In some embodiments, said set of outgoing packets comprise video content of said single application, wherein said video content is encoded to include: (i) a base-quality encoded video layer packets and (ii) a higher-quality encoded video layer packets; wherein the base-quality encoded video layer packets are transmitted from said cellular transmitting device to said recipient device over the first cellular slice; wherein the higher-quality encoded video layer packets are transmitted from said cellular transmitting device to said recipient device over the second, different, cellular slice.

In some embodiments, said set of outgoing packets comprise (i) encoded video packets, and (ii) error correction data, that correspond to the same video content; wherein the encoded video packets are transmitted from said cellular transmitting device to said recipient device over the first cellular slice; wherein error correction data is transmitted from said cellular transmitting device to said recipient device over the second, different, cellular slice.

Some embodiments provide a method for transmitting a group of outgoing data packets of a first single application, from a cellular transmitting device to a recipient device. The method may include: allocating, by a Bonding Unit of said cellular transmitting device, at an application level or at an Internet Protocol (IP) level, (I) a first subset of said outgoing packets of said single application, for transmission from said cellular transmitting device over a first communication link that utilizes a first cellular slice of a first cellular communication network, wherein said first cellular slice is associated with a first Cellular Identity Profile and with a first set of Quality-of-Service (QOS) parameters, and (II) a second subset of said outgoing packets of said single application, for simultaneous transmission from said cellular transmitting device over a second communication link of said first cellular communication network; wherein said second communication link is associated with said first Cellular Identity Profile and with a second set of QoS parameters; wherein said cellular transmitting device (I) is associated with a first cellular transceiver, that is configured to transmit said first subset of said outgoing packets via said first cellular communication link that utilizes said first cellular slice, and (II) is further configured to simultaneously transmit said second subset of said outgoing packets via said second cellular communication link.

In some embodiments, optionally, the cellular transmitting device and/or its Bonding Unit or Bonding Engine or other component may include a Slice (or sub-slice) Requesting Unit, configured to send a signal to one or more cellular communication network, indicating a request that such cellular network would allocate/reserve/designate/assign a cellular slice (or a cellular sub-slice) having a particular set of QoS parameters, or having a particular single QoS parameter (e.g., latency; error rate; minimum guaranteed bandwidth), or a cellular slice (or sub-slice) of a particular type (e.g., a Guaranteed Minimum Bandwidth slice or sub-slice; or a Best Effort/Non-Guaranteed Minimum Bandwidth slice or sub-slice); or a request to be assigned a particular mixture or combinations of such slices and/or sub-slices.

The system(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic sensor(s), optical sensor(s), wired or wireless modems or transceivers or transmitters or receivers, GPS receiver or GPS element or other location-based or location-determining unit or system, network functions/network elements (e.g., routers, switches, hubs, antennas), and/or other suitable components and/or modules. The system(s) of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Rust, Cobol, Fortran, ActionScript, AJAX, XML, JSON, Lisp, Eiffel, Verilog, Hardware Description Language (HDL), BASIC, Visual BASIC, MATLAB, Pascal, Dart, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, “estimating”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated or collected data, and one or more values as stored in a look-up table or a legend table or a list of reference value(s) or a database of reference values or a ranges of reference-values; a comparison or matching or searching process which searches for matches and/or identical results and/or similar results and/or sufficiently-similar results (e.g., within a pre-defined threshold level of similarity; such as, within 5 percent above or below a pre-defined threshold value), among multiple values or limits that are stored in a database or look-up table or that are defined by comparison rules or matching rules; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A system comprising:
a cellular transmitting device, configured to transmit, using at least a first associated transmitter, to a recipient device a set of outgoing packets that belong to a single application;
wherein the cellular transmitting device comprises a Bonding Unit that is configured to allocate, at an application level or at an Internet Protocol (IP) level,
(I) a first subset of said outgoing packets of said single application for transmission from said cellular transmitting device over a first communication link that utilizes a first cellular slice of a first cellular communication network,
wherein said first cellular slice is associated with a first Cellular Identity Profile and with a first set of Quality-of-Service (QOS) parameters,
and
(II) a second subset of said outgoing packets of said single application for simultaneous transmission from said cellular transmitting device over a second communication link of said first cellular communication network;
wherein said second communication link is associated with said first Cellular Identity Profile and with a second set of QoS parameters;
wherein said cellular transmitting device (I) is associated with a first cellular transceiver, that is configured to transmit said first subset of said outgoing packets via said first cellular communication link that utilizes said first cellular slice, and (II) is further configured to simultaneously transmit said second subset of said outgoing packets via said second cellular communication link.

2. The system of claim 1,
wherein said second communication link is associated with a second cellular slice that is associated with a second set of QoS parameters, and wherein said second cellular slice is manifested by said first cellular communication network.

3. The system of claim 1,
wherein the Bonding Unit of said cellular transmitting device is configured to further allocate, at the application level or at the Internet Protocol (IP) level,
a third subset of said outgoing packets of said single application for transmission from said cellular transmitting device over a third communication link that utilizes a third cellular slice of a second cellular communication network that is different from said first cellular communication network;
wherein said third communication link, that utilizes said third cellular slice, is associated with a second, different, Cellular Identity Profile and with a third set of QoS parameters;
wherein said third set of QoS parameters for said third cellular slice is manifested by said second cellular communication network;
wherein said Bonding Unit allocates zero or more packets into said second subset of outgoing packets for transmission via the second cellular communication link;
wherein transmission of the first subset of outgoing packets is performed via said first cellular transceiver that is associated with said first Cellular Identity Profile;
wherein transmission of the third subset of outgoing packets is performed, simultaneously, via a second cellular transceiver that is associated with said second Cellular Identity Profile.

4. The system of claim 1,
wherein each Cellular Identity Profile that is utilized by said cellular transmitting device, is defined by one of: a unique Subscriber Identity Module (SIM), a unique Embedded SIM (eSIM), a unique Virtual SIM (vSIM), a unique International Mobile Subscriber Identity (IMSI) number, a unique Universal Integrated Circuit Card (UICC), a subscriber Profile ID.

5. The system of claim 1,
wherein at least some packets of said set of outgoing packets of said single application, are transmitted from said cellular transmitting device to said recipient device over said first cellular slice which is associated with a published guaranteed minimum bandwidth;
wherein at least some other packets of said set of outgoing packets of said single application, are transmitted from said cellular transmitting device to said recipient device over said second cellular communication link which is a cellular communication link that does not have a published guaranteed minimum bandwidth and that operates on a best effort basis.

6. The system of claim 1,
wherein the Bonding Unit is configured to allocate the first subset of outgoing packets of said single application for transmission via the first cellular slice, and to allocate the second subset of outgoing packets of said single application for transmission via the second, different, cellular communication link,
based on a cellular slices allocation scheme that takes into account at least one of:
published minimum bandwidth of each cellular slice,
expected bandwidth of each cellular slice,
estimated latency of each cellular slice,
estimated error rate of each cellular slice.

7. The system of claim 1,
wherein said set of outgoing packets of said single application comprise at least two packet-types from the group consisting of:
video packets, audio packets, data packets, error correction packets, control packets;
wherein packets of a first type from said group, of said single application, are transmitted from said cellular transmitting device to said recipient device over the first cellular slice;
wherein packets of a second, different, type from said group, of said single application, are transmitted from said cellular transmitting device to said recipient device over the second, different, cellular communication link.

8. The system of claim 3,
wherein said first cellular slice and said third cellular slice are specifically selected from a pool of available cellular slices, based on having sufficiently similar performance characteristics beyond a pre-defined threshold level of similarity.

9. The system of claim 3,
wherein said first cellular slice and said third cellular slice are specifically selected from a pool of available cellular slices by using a cellular slices allocation scheme that is configured to create a bonded virtual communication link having bandwidth and transmission characteristics that are sufficient for timely and correctly delivering said set of outgoing data packets of said single application from said cellular transmitting device to said recipient device;
wherein said bonded virtual communication link is comprised of a plurality of different cellular slices of at least one cellular communication network.

10. The system of claim 9,
wherein, based on characteristics of said bonded virtual communication link, one or more of the following modifications are performed:
(a) one or more Forward Error Correction (FEC) parameters are adjusted by the cellular transmitting device;
(b) a size of a Packet Reception Jitter Buffer is modified at said recipient device;
(c) one or more Video Encoding parameters are adjusted at a video encoder that is associated with said cellular transmitting device.

11. The system of claim 1,
wherein the cellular transmitting device is configured to estimate that in view of particular performance characteristics of the first cellular slice, a size of a Packet Reception Jitter Buffer at the recipient device can be reduced; and is configured to send a signal that indicates to the recipient device to reduce accordingly the size of its Packet Reception Jitter Buffer.

12. The system of claim 3,
wherein the recipient device comprises:
one or more receivers, configured to receive incoming packets from said cellular transmitting device;
a receiver-side Reception Jitter Buffer Size Modification Unit, (a) configured to define a first Packet Reception Jitter Buffer for receiving incoming packets that are received for said single application via said first cellular slice, and (b) configured to define a second, separate, Packet Reception Jitter Buffer for receiving incoming packets that are received for said single application via said third cellular slice;
wherein the receiver-side Reception Jitter Buffer Size Modification Unit is configured to dynamically modify a size of at least one of: the first Packet Reception Jitter Buffer, the second Packet Reception Jitter Buffer, based on a Jitter Buffer Size Modification Signal that is received at the recipient device from the cellular transmitting device,
wherein said Jitter Buffer Size Modification Signal is generated by the cellular transmitting device based on at least one of: (i) a signal from performance characteristics of the first cellular slice that is used by the cellular transmitting device, (ii) performance characteristics of the third cellular slice that is used by the cellular transmitting device.

13. The system of claim 1,
wherein at least the first cellular slice is: a cellular sub-slice of a parent cellular slice that was divided by a cellular network element into at least two cellular sub-slices.

14. The system of claim 3,
wherein the first cellular slice is: a first cellular sub-slice of a first parent cellular slice that was divided by a cellular network element into a plurality of cellular sub-slices;
wherein the third cellular slice is: a second cellular sub-slice of a second, different, parent cellular slice that was divided by the cellular network element into a plurality of cellular sub-slices.

15. The system of claim 3,
wherein the first cellular slice is: a first cellular sub-slice of a first parent cellular slice that was divided by a cellular network element into a plurality of cellular sub-slices; wherein said first cellular sub-slice is associated with a published minimum bandwidth;
wherein the third cellular slice is: a second cellular sub-slice of a second, different, parent cellular slice that was divided by the cellular network element into a plurality of cellular sub-slices;
wherein said third cellular sub-slice is not associated with a published minimum bandwidth and is operated on a best effort basis.

16. The system of claim 13,
wherein at least one cellular sub-slice, of a group of sub-slices that were divided from the same single cellular parent slice, is initially allocated to a first Customer Identity Profile that is utilized by said cellular transmitting device;
wherein said at least one cellular sub-slice, is subsequently released from being allocated to said first Customer Identity Profile, and is re-allocated, based on one or more sub-slices release and re-allocation rules, to the second Customer Identity Profile.

17. The system of claim 13,
wherein the Bonding Unit of the cellular transmitting device is configured to distribute the outgoing packets for transmission over at least two different communication routes from the following group:
a first cellular slice;
a second, different, cellular slice;
a Wi-Fi communication link.

18. The system of claim 13,
wherein the Bonding Unit of the cellular transmitting device is configured to distribute the outgoing packets for transmission over at least two different communication routes from the following group:
a first cellular sub-slice of a parent cellular slice;
a second, different, cellular sub-slice of said parent cellular slice;
a Wi-Fi communication link.

19. The system of claim 3,
wherein the first cellular slice is one of: (a) a first network-defined cellular slice that is manifested by the first cellular communication network; (b) a first differentiated set of QoS parameters that is defined by said first cellular communication network to be associated with said first cellular communication link via said first Cellular Identity Profile;
wherein the third cellular slice is one of: (a) a second network-defined cellular slice that is manifested by the first cellular communication network; (b) a second differentiated set of QoS parameters that is defined by said first cellular communication network to be associated with said third cellular communication link via said second Cellular Identity Profile.

20. The system of claim 1,
wherein the cellular transmitting device is configured to overwrite a value of at least one Transmission Control Protocol (TCP) parameter, of a TCP-based wireless routing of the said single application, wherein said single application is utilizing TCP,
based on estimated or expected performance characteristics of the first cellular slice.

21. The system of claim 2,
wherein said set of outgoing packets comprise video content of said single application,
wherein said video content is encoded to include: (i) a base-quality encoded video layer packets and (ii) a higher-quality encoded video layer packets;
wherein the base-quality encoded video layer packets are transmitted from said cellular transmitting device to said recipient device over the first cellular slice;
wherein the higher-quality encoded video layer packets are transmitted from said cellular transmitting device to said recipient device over the second, different, cellular slice.

22. The system of claim 2,
wherein said set of outgoing packets comprise (i) encoded video packets, and (ii) error correction data, that correspond to the same video content;
wherein the encoded video packets are transmitted from said cellular transmitting device to said recipient device over the first cellular slice;
wherein error correction data is transmitted from said cellular transmitting device to said recipient device over the second, different, cellular slice.

23. A method for transmitting a group of outgoing data packets of a single application, from a cellular transmitting device to a recipient device,
the method comprising:
allocating, by a Bonding Unit of said cellular transmitting device, at an application level or at an Internet Protocol (IP) level,
(I) a first subset of said outgoing packets of said single application, for transmission from said cellular transmitting device over a first communication link that utilizes a first cellular slice of a first cellular communication network,
wherein said first cellular slice is associated with a first Cellular Identity Profile and with a first set of Quality-of-Service (QOS) parameters,
and
(II) a second subset of said outgoing packets of said single application, for simultaneous transmission from said cellular transmitting device over a second communication link of said first cellular communication network;
wherein said second communication link is associated with said first Cellular Identity Profile and with a second set of QoS parameters;
wherein said cellular transmitting device (I) is associated with a first cellular transceiver, that is configured to transmit said first subset of said outgoing packets via said first cellular communication link that utilizes said first cellular slice, and (II) is further configured to simultaneously transmit said second subset of said outgoing packets via said second cellular communication link.
